(19) United States
(12) Patent Application Publication
(10) Pub. No.: US 2023/0343268 A1
(43) Pub. Date: Oct. 26, 2023

(54) PIXEL CIRCUIT, DRIVING METHOD THEREOF AND DISPLAY DEVICE AND BACKPLANE THEREOF

(71) Applicant: ULTRADISPLAY INC., Zhubei City (TW)

(72) Inventors: Shih-Song CHENG, Zhubei City (TW); Dsun-Chie TWU, Zhubei City (TW)

(73) Assignee: ULTRADISPLAY INC., Zhubei City (TW)

(21) Appl. No.: 18/137,213

(22) Filed: Apr. 20, 2023

(30) Foreign Application Priority Data
Apr. 20, 2022 (TW) 111115069

(51) Int. Cl. G09G 3/32; G09G 3/20

(52) U.S. Cl. CPC G09G 3/2007; G09G 3/32; G09G 2300/0852; G09G 2310/061; G09G 2310/08

(57) ABSTRACT

Embodiments of the present disclosure provide a pixel circuit and a backplane and a display device thereof. The pixel circuit is used for being provided on the backplane of the display device, and includes a data selecting circuit, a latch circuit, a driving circuit, and a switching circuit. The latch circuit is configured to control the data selecting circuit to switch between different data paths on a basis of time axis. The data selecting circuit is configured to provide corresponding grayscale signal, so that the driving circuit generates the corresponding light-emitting signal, and provides the same to the electroluminescent element via the switching circuit to drive the electroluminescent element to emit light with different grayscales. By switching between different data paths, a high bit depth can be achieved, and the real grayscale of pixels can be presented, the mixing problems of grayscales caused by small data ranges are improved and the display quality of the display device is increased.

### CROSS REFERENCE TO RELATED DISCLOSURES

This disclosure claims priority to Taiwan Patent Disclosure No. 111115069, filed on Apr. 20, 2022, entitled “Pixel circuit, driving method thereof and display, and backplane thereof”, which is hereby incorporated by reference in its entirety.

### TECHNICAL FIELD

The present disclosure relates to a field of pixel circuits, in particular to a pixel circuit for an electroluminescent display.

### BACKGROUND

A electroluminescence display uses light Emitting Diode (LED) or Organic Light Emitting Diode (OLED) as a light-emitting device, and is widely used in consumer and industrial fields nowadays. The improving of display quality is an important and continuous target in developing display technique. No matter the driving substrate of a display uses the Thin Film Transistor (TFT) process used in a traditional display or the CMOS (Complementary Metal-Oxide-Semiconductor) process used in a micro display, a very strict requirement is applied on the photoelectric conversion accuracy, and a precise definition on grayscale determines the display quality.

In such displays, the data precision of grayscale is usually set by using a driving method in an analog way. Such data precision is a ratio of bit depth (or grayscale depth) to data range, and thus it is necessary for the pixel circuit to be operated in a larger data range, if the bit depth is to be increased while the data precision is kept the same. However, such method is limited by the performance of the device made in the process, and when the bit depth that the hardware architecture can achieve is fixed, the driver cannot perform switch for more grayscales in a fixed data range, which often renders grayscale mixed and the quality it can present is degraded.

### BRIEF SUMMARY

Aspects of the present disclosure provide a pixel circuit and a backplane thereof a driving method thereof and a display device which may conduct switch among various grayscale in a small data range and the display quality is improved.

An embodiment of the present disclosure provides a pixel circuit, which may control the grayscale of an electroluminescent element. The pixel circuit includes: a data selecting circuit configured to receive a first data voltage and a second data voltage, and selectively generate a first grayscale signal corresponding to the first data voltage and a second grayscale signal corresponding to the second data voltage according to a time voltage; a latch circuit, coupled to the data selecting circuit, and configured to receive and transmit the time voltage; a driving circuit, coupled to the data selecting circuit, and configured to transmit a first light-emitting signal in response to the first grayscale signal and transmit a second light-emitting signal in response to the second grayscale signal; and a switching circuit, coupled to the driving circuit and the electroluminescent element respectively, and configured to transmit the first light-emitting signal to the electroluminescent element to drive the electroluminescent element to emit light with a first grayscale of a bit depth, or transmit the second luminescent signal to the electroluminescent element to drive the electroluminescent element to emit light with a second grayscale, wherein the second grayscale is one of a plurality of sub-grayscales between the first grayscale and a previous or next grayscale of the first grayscale at the bit depth.

In one embodiment of the present disclosure, the data selecting circuit further includes: a first transistor, coupled to a first node, and configured to transmit a first voltage or a first data voltage to the first node in response to a first control signal; a third transistor, coupled to a third node, and configured to transmit a second data voltage to the third node in response to the first control signal; a fifth transistor, coupled between a second node and the latch circuit, and configured to transmit a reference voltage to the second node in response to the time voltage; a sixth transistor, coupled between the third node and the latch circuit, and configured to transmit the reference voltage to the third node in response to the time voltage; and an eighth transistor, coupled to the fifth transistor and the sixth transistor respectively, and configured to transmit the reference voltage in response to a third control signal.

In one embodiment of the present disclosure, the first transistor includes a gate electrode configured to be in response to the first control signal; a first terminal configured to receive the first voltage or the first data voltage; and a second terminal, coupled to the first node. The third transistor includes a gate electrode configured to be in response to the first control signal; a first terminal configured to receive the second data voltage; and a second terminal coupled to the third node. The fifth transistor includes a gate electrode coupled to the latch circuit and configured to be in response to the time voltage; a first terminal coupled to the eighth transistor; and a second terminal, coupled to the second node. The sixth transistor includes a gate electrode coupled to the latch circuit and configured to be in response to the time voltage; a first terminal coupled to the eighth transistor; and a second terminal coupled to the third node. The eighth transistor includes a gate electrode configured to be in response to the third control signal; a first terminal configured to receive the reference voltage; and a second terminal coupled to the fifth transistor and the sixth transistor, respectively.

In one embodiment of the present disclosure, the first terminal of the first transistor is configured to receive the first voltage. The first transistor is configured to transmit the first voltage to the first node in response to the first control signal, and the data selecting circuit further includes a second transistor coupled to the second node, and configured to transmit the first data voltage to the second node in response to the first control signal.

In one embodiment of the present disclosure, the second transistor includes a gate electrode configured to be in response to the first control signal; a first terminal configured to receive the first data voltage; and a second terminal coupled to the second node.

In one embodiment of the present disclosure, the fifth transistor is a first-type transistor, and the remaining transistors are second-type transistors.

In one embodiment of the present disclosure, the data selecting circuit further includes a third capacitor, one end of the third capacitor is coupled to a DC voltage source, and the other end of the third capacitor is coupled between a first capacitor and a second capacitor, and configured to stabilize the voltage level of the first node.

In one embodiment of the present disclosure, the latch circuit further includes: a set of back-to-back inverters, coupled to a fourth node, and the fourth node is coupled to the data selecting circuit. More particularly, the time voltage is applied to the fourth node, and the back-to-back inverter is configured to maintain the voltage level of the fourth node.

In one embodiment of the present disclosure, the set of back-to-back inverters include a first inverter and a second inverter. A first output terminal of the first inverter is coupled to a second input terminal of the second inverter, and a second output terminal of the second inverter is coupled to a first input terminal of the first inverter, wherein the fourth node is located on a side close to the first output terminal or a side close to the second output terminal.

In one embodiment of the present disclosure, the time voltage includes a first time voltage and a second time voltage. The latch circuit is configured to transmit the first time voltage to the fourth node in a first time stage, and transmit the second time voltage to the fourth node in a second time stage. The data selecting circuit is configured to transmit the reference voltage to the second node in response to the first time voltage, and transmit the reference voltage to the third node in response to the second time voltage.

In one embodiment of the present disclosure, the fourth node is located on a side close to the first output, and a fifth node is located on a side close to the second output. The first time voltage is applied to the fourth node, the second time voltage is applied to the fifth node, and the set of back-to-back inverters are further configured to maintain the voltage level of the fifth node.

In one embodiment of the present disclosure, the latch circuit further includes a seventh transistor coupled to the fourth node and/or the fifth node, and configured to transmit the first time voltage and/or the second time voltage in response to the second control signal.

In one embodiment of the present disclosure, the latch circuit further includes an eleventh transistor coupled to the fourth node. The eleventh transistor is configured to transmit the first time voltage to the fourth node in response to the first control signal. The seventh transistor is configured to transmit the second time voltage to the fourth node or the fifth node in response to the second control signal.

In one embodiment of the present disclosure, the driving circuit includes: a fourth transistor, including a gate electrode coupled to the first node and configured to generate the first light-emitting signal in response to the first grayscale signal and generate the second light-emitting signal in response to the second grayscale signal; a first terminal configured to receive the first voltage; and a second terminal coupled to the switching circuit.

In one embodiment of the present disclosure, the switching circuit includes: a ninth transistor, including a gate electrode configured to transmit the first light-emitting signal and the second light-emitting signal in response to a light-emitting control signal; a first terminal coupled to the electroluminescent element; and a second terminal coupled to the driving circuit and configured to receive the first light-emitting signal and the second light-emitting signal.

In one embodiment of the present disclosure, the pixel circuit further includes a reset circuit, coupled between the switching circuit and the electroluminescent element, and configured to transmit another reference voltage to the electroluminescent element in response to a reset signal, to reset the voltage level of the electroluminescent element.

In one embodiment of the present disclosure, the reset circuit includes: a tenth transistor, including a gate electrode configured to be in response to the reset signal; a first terminal configured to receive the another reference voltage; and a second terminal coupled between the switching circuit and the electroluminescent element.

In one embodiment of the present disclosure, the data selecting circuit is coupled to a data line, a first signal line, and a first signal branch line, respectively, the data selecting circuit is configured to transmit a first data voltage of the data line to the first node or the second node in response to a first control signal of the first signal line, and transmit a second data voltage of the data line to the third node in response to a first branch control signal of the first signal branch line.

In one embodiment of the present disclosure, the data selecting circuit further includes: a first transistor coupled to the first signal line and the first node respectively and configured to transmit the first voltage or the first data voltage to the first node in response to the first control signal; a third transistor coupled to the data line, the first signal branch line, and the third node, respectively, and configured to transmit the second data voltage to the third node in response to the first branch control signal; a fifth transistor coupled between the second node and the latch circuit and configured to transmit the reference voltage to the second node in response to the time voltage; a sixth transistor coupled between the third node and the latch circuit and configured to transmit the reference voltage to the third node in response to the time voltage; and an eighth transistor coupled to the fifth transistor and the sixth transistor, respectively, and configured to transmit the reference voltage in response to a third control signal.

In one embodiment of the present disclosure, the data selecting circuit further includes a second transistor. The first transistor is configured to transmit the first voltage to the first node in response to the first control signal. The second transistor is coupled to the data line, the first signal branch line, and the second node, respectively, and configured to transmit the first data voltage to the second node in response to the first branch control signal.

Another embodiment of the present disclosure provides a backplane of a display device, including: a substrate; and the pixel circuit as described above, the pixel circuit is disposed on the substrate.

Other embodiments of the present disclosure provide a display device, including: a display panel; and a backplane, including a substrate and a pixel circuit as described above disposed on the substrate.

An embodiment of the present disclosure also provides a driving method of a pixel circuit, for controlling grayscales of the electroluminescent element. The driving method includes: establishing a first data voltage and a second data voltage in a data selecting circuit; transmitting a reference voltage to a second node according to a time voltage and generating a first grayscale signal corresponding to the first data voltage at a first node, or transmitting a reference voltage to a third node and generating a second grayscale signal corresponding to the second data voltage at the first node; ; and driving an electroluminescent element to emit light with a first grayscale at a bit depth according to the first light-emitting signal; or driving the electroluminescent element to emit light with a second grayscale according to the second light-emitting signal, wherein the second grayscale is one of a plurality of sub-grayscales between the first grayscale and a previous or next grayscale of the first grayscale at the bit depth.

In one embodiment of the present disclosure, the driving method further includes: establishing the time voltage at a fourth node; applying a first control signal or a second control signal to a latch circuit for receiving and transmitting the time voltage to the fourth node to establish a first time voltage at a first time stage; and applying the second control signal to the latch circuit for receiving and transmitting the time voltage to the fourth node or a fifth node to establish a second time voltage at a second time stage.

In one embodiment of the present disclosure, the driving method further includes: applying a third control signal to the data selecting circuit for receiving the reference voltage, and transmitting the reference voltage to the second node according to the first time voltage and transmitting the reference voltage to the third node according to the second time voltage.

In one embodiment of the present disclosure, the driving method further includes: applying the first control signal to the data selecting circuit at the first time stage; transmitting the first data voltage to the first node or the second node for establishing the first data voltage; and transmitting the second data voltage to the third node for establishing the second data voltage.

In one embodiment of the present disclosure, the driving method further includes: transmitting a first voltage to the first node according to the first control signal for establishing the first voltage; transmitting the first data voltage to the second node for establishing the first data voltage; and transmitting the second data voltage to the third node for establishing the second data voltage.

In one embodiment of the present disclosure, the driving method further includes: turning on a first transistor according to the first control signal to transmit the first voltage to the first node; turning on a second transistor to transmit the first data voltage to the second node; turning on a third transistor to transmit the second data voltage to the third node; maintaining a potential difference between the first node and the second node by means of a first capacitor of the data selecting circuit; and maintaining a potential difference between the second node and the third node by means of a second capacitor of the data selecting circuit.

In one embodiment of the present disclosure, the driving method further includes: turning off the first transistor, the second transistor and the third transistor at the first time stage; applying the third control signal to the data selecting circuit, turning on an eighth transistor to receive and transmit the reference voltage; applying the first time voltage to the data selecting circuit, turning on a fifth transistor to transmit the reference voltage to the second node; generating the first grayscale signal at the first node according to the change of a voltage of the second node; applying the first grayscale signal to the driving circuit, turning on a fourth transistor to generate the first light-emitting signal; applying a light-emitting control signal to a switching circuit, turning on a ninth transistor to receive the first light-emitting signal; and transmitting the first light-emitting signal to the electroluminescent element, and driving the electroluminescent element to emit light with the first grayscale.

In one embodiment of the present disclosure, the driving method further includes: turning off the fifth transistor at the second time stage; applying the second control signal to the latch circuit, turning on a seventh transistor to transmit the second time voltage to the fourth node; applying the second time voltage to the data selecting circuit, turning on a sixth transistor to transmit the reference voltage to the third node; generating the second grayscale signal at the first node according to the change of a voltage of the third node; applying the second grayscale signal to the driving circuit, turning on the fourth transistor to generate the second light-emitting signal; applying the light-emitting control signal to the switching circuit, turning on the ninth transistor to receive the second light-emitting signal; and transmitting the second light-emitting signal to the electroluminescent element, and driving the electroluminescent element to emit light with the second grayscale.

In one embodiment of the present disclosure, the driving method further includes: transmitting the reference voltage to the second node according to the third control signal for establishing the reference voltage at the second node; and transmitting the first data voltage to the first node for establishing the first data voltage at the first node and the second data voltage to the third node for establishing the second data voltage at the third node according to the first control signal, respectively.

In one embodiment of the present disclosure, the driving method further includes: turning on the eighth transistor according to the third control signal for receiving and transmitting the reference voltage to the second node; turning on the first transistor to transmit the first data voltage to the first node according to the first control signal, and turning on the third transistor to transmit the second data voltage to the third node; maintaining a potential difference between the first node and the second node by means of the first capacitor of the data selecting circuit; and maintaining a potential difference between the second node and the third node by means of the second capacitor of the data selecting circuit.

In one embodiment of the present disclosure, the driving method further includes: turning off the first transistor and the third transistor; applying the first time voltage to the data selecting circuit, turning on the fifth transistor to transmit the reference voltage to the second node; generating the first grayscale signal at the first node according to a change of a voltage of the second node; applying the first grayscale signal to the driving circuit, turning on the fourth transistor to generate the first light-emitting signal; applying a light-emitting control signal to the switching circuit, turning on the ninth transistor to receive the first light-emitting signal; and transmitting the first light-emitting signal to the electroluminescent element, and driving the electroluminescent element to emit light with the first grayscale.

In one embodiment of the present disclosure, the driving method further includes: turning off the fifth transistor at the second time stage; applying the second control signal to the latch circuit, turning on the seventh transistor to transmit the second time voltage to the fourth node; applying the second time voltage to the data selecting circuit, turning on the sixth transistor to transmit the reference voltage to the third node; generating the second grayscale signal at the first node according to a change of a voltage of the third node; applying the second grayscale signal to the driving circuit, turning on the fourth transistor to generate the second light-emitting signal; applying the light-emitting control signal to the switching circuit, turning on the ninth transistor to receive the second light-emitting signal; and transmitting the second light-emitting signal to the electroluminescent element, and driving the electroluminescent element to emit light with the second grayscale.

In one embodiment of the present disclosure, the driving method further includes: applying the first control signal to the latch circuit at the first time stage to receive the first voltage, and using the first voltage as the first time voltage; and applying the second control signal to the latch circuit to receive the second time voltage at the second time stage.

In one embodiment of the present disclosure, the driving method further includes: applying the second control signal to the latch circuit at the first time stage to receive the first time voltage; and applying the second control signal to the latch circuit at the second time stage to receive the second time voltage.

In one embodiment of the present disclosure, the driving method further includes: establishing the first time voltage at the fourth node at the first time stage; transmitting the reference voltage to the second node according to the first time voltage by the data selecting circuit to generate the first grayscale signal; establishing the second time voltage at the fifth node at the second time stage; and transmitting the reference voltage to the third node according to the second time voltage by the data selecting circuit to generate the second grayscale signal.

In one embodiment of the present disclosure, the driving method further includes: applying the first control signal to the data selecting circuit at the first time stage; transmitting the first data voltage to the first node or the second node for establishing the first data voltage; applying a first branch control signal to the data selecting circuit; and transmitting the second data voltage to the third node for establishing the second data voltage.

In one embodiment of the present disclosure, the driving method further includes: applying a light-emitting control signal to the switching circuit, receiving the first light-emitting signal and the second light-emitting signal from the driving circuit, and transmitting the first light-emitting signal and the second light-emitting signal to the electroluminescent element.

In one embodiment of the present disclosure, the driving method further includes: applying a reset signal to a reset circuit to receive and transmit another reference voltage to the electroluminescent element; and resetting a voltage level of the electroluminescent element according to the another reference voltage.

The pixel circuit provided in the embodiment of the present disclosure sets the main grayscale value of pixels precisely by a driving method in an analog way, realizes the presentation of real grayscales along with a driving method of arithmetic grayscale on the time axis, improves the grayscale-mixing problem caused by too small data range, and can specifically improve the display quality of the display device.

### BRIEF DESCRIPTION OF THE DRAWINGS

The drawings described herein are intended to provide a further understanding of the present disclosure, and are incorporated in and constitute a part of this specification, schematic embodiments of the disclosure and together with the description serve to explain the principles of the present disclosure, and do not constitute an improper limitation of the present disclosure. It should be noted that, in accordance with standard practice in the art, the features in the diagram are not drawn to scale. In fact, the dimensions of certain features may be deliberately enlarged or reduced for clear description. In the drawings:

FIG. 1 is a block diagram of the display device according to an embodiment of the present disclosure.

FIG. 2 is a block diagram of a backplane of the display device according to an embodiment of the present disclosure.

FIG. 3a shows the relationship between the driving voltage and the driving current of a general electroluminescent element.

FIG. 3b shows the relationship between the time and brightness of a general electroluminescent element.

FIG. 3c and FIG. 3d show the relationship between the time and brightness of the electroluminescent element according to an embodiment of the present disclosure.

FIG. 3e is a schematic diagram of the first grayscale and the second grayscale according to an embodiment of the present disclosure.

FIG. 4 is a circuit diagram of a pixel circuit according to an embodiment of the present disclosure.

FIG. 5 is a flowchart of the driving method of a pixel circuit according to an embodiment of the present disclosure.

FIG. 6 is a circuit diagram of a pixel circuit according to one embodiment of the present disclosure.

FIG. 7a is an operation timing diagram of the pixel circuit according to the embodiment shown in FIG. 6 at time t1 of the first time stage.

FIG. 7b is a schematic diagram of the operation of the pixel circuit according to the embodiment shown in FIG. 6 at time t1 shown in FIG. 7a.

FIG. 8a is an operation timing diagram of the pixel circuit according to the embodiment shown in FIG. 6 at time t2 of the first time stage.

FIG. 8b is a schematic diagram of the operation of the pixel circuit according to the embodiment shown in FIG. 6 at time t2 shown in FIG. 8a.

FIG. 9a is an operation timing diagram of the pixel circuit according to the embodiment shown in FIG. 6 at time t3 of the first time stage.

FIG. 9b is a schematic diagram of the operation of the pixel circuit according to the embodiment shown in FIG. 6 at time t3 shown in FIG. 9a.

FIG. 10a is an operation timing diagram of the pixel circuit according to the embodiment shown in FIG. 6 at time tn1 of the second time stage.

FIG. 10b is a schematic diagram of the operation of the pixel circuit according to the embodiment shown in FIG. 6 at time tn1 shown in FIG. 10a.

FIG. 11a is an operation timing diagram of the pixel circuit according to the embodiment shown in FIG. 6 at time tn2 of the second time stage.

FIG. 11b is a schematic diagram of the operation of the pixel circuit according to the embodiment shown in FIG. 6 at time tn2 shown in FIG. 11a.

FIGS. 12 and 13 are respectively flowcharts of the driving method of the pixel circuit according to the embodiment shown in FIG. 6.

FIG. 14 is a circuit diagram of a pixel circuit according to an embodiment of the present disclosure.

FIG. 15 is a circuit diagram of a pixel circuit according to an embodiment of the present disclosure.

FIG. 16 is a circuit diagram of a pixel circuit according to an embodiment of the present disclosure.

FIG. 17 shows a circuit diagram of the equivalent circuit of the pixel circuit shown in FIG. 16.

FIG. 18 is a circuit diagram of a pixel circuit of an embodiment of the present disclosure.

FIG. 19 is a circuit diagram of a pixel circuit of an embodiment of the present disclosure.

FIG. 20 is a circuit diagram of a pixel circuit of an embodiment of the present disclosure.

FIG. 21a is an operation timing diagram of the pixel circuit according to the embodiment shown in FIG. 20 at time t1 of the first time stage.

FIG. 21b is a schematic diagram of the operation of the pixel circuit according to the embodiment shown in FIG. 20 at time t1 shown in FIG. 21a.

FIG. 22a is an operation timing diagram of the pixel circuit according to the embodiment shown in FIG. 20 at time t2 of the first time stage.

FIG. 22b is a schematic diagram of the operation of the pixel circuit according to the embodiment shown in FIG. 20 at time t2 shown in FIG. 22a.

FIG. 23a is an operation timing diagram of the pixel circuit according to the embodiment shown in FIG. 20 at time tn1 of the second time stage.

FIG. 23b is a schematic diagram of the operation of the pixel circuit according to the embodiment shown in FIG. 20 at time tn1 shown in FIG. 23a.

FIG. 24a is an operation timing diagram of the pixel circuit according to the embodiment shown in FIG. 20 at time tn2 of the second time stage.

FIG. 24b is a schematic diagram of the operation of the pixel circuit according to the embodiment shown in FIG. 20 at time tn2 shown in FIG. 24a.

FIG. 25 is a flowchart of the driving method of the pixel circuit according to the embodiment of FIG. 20.

FIG. 26 is a circuit diagram of a pixel circuit according to an embodiment of the present disclosure.

FIG. 27 is an operation timing diagram of the pixel circuit according to the embodiment of FIG. 26 at the first time stage.

### DETAILED DESCRIPTION

Hereinafter, the present disclosure will be described in detail with reference to the accompanying drawings along with illustrated embodiments, so as to better clarify the object, technical solution and advantageous of the present disclosure. It can be conceivable that such descriptions are merely exemplary and are not intended to limit the present disclosure.

Transistors used in all embodiments of the present disclosure may be thin-film transistors or field-effect transistors or other devices with the same characteristics. In embodiments of the present disclosure, in order to distinguish the two electrodes of the transistor other than the gate electrode (Gate), one of the two electrodes may be referred as the first electrode, and the other electrode may be referred as the second electrode. One skilled in the art would understand that the drain and source of the transistor are interchangeable, depending on the voltage level applied thereto. Therefore, in practical operations, the first electrode may be the drain electrode, and the second electrode may be the source electrode; alternatively, the first electrode may be the source electrode, and the second electrode may be the drain electrode.

Further, it should be understood that if one component is described as being “connected to” or “coupled to” another component, these two components may be directly connected or coupled to each other, or there may be other intervening component therebetween. Further, when a device is of the type of positive edge trigger (active high), a signal is asserted to a high logical level to start the device. Conversely, the signal is deasserted to a low logical level to deactivate the device. However, when a device is of the type of negative edge trigger (active low), a signal is deasserted to a low logical level to start the device, and it is asserted to a high logical level to deactivate the device.

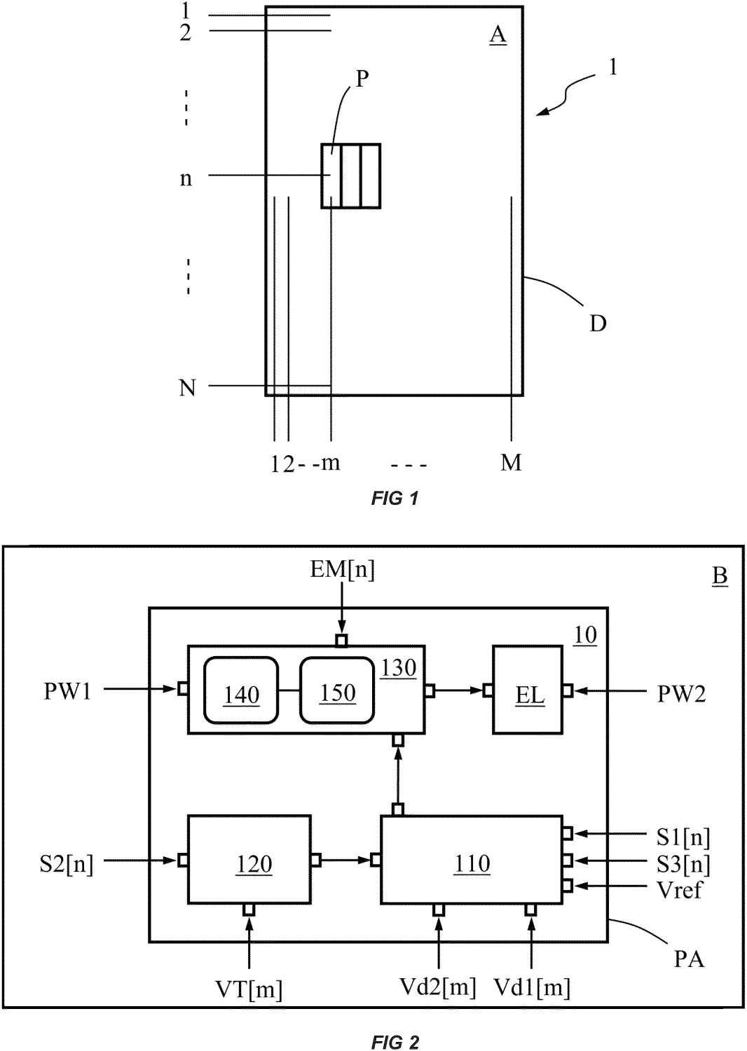

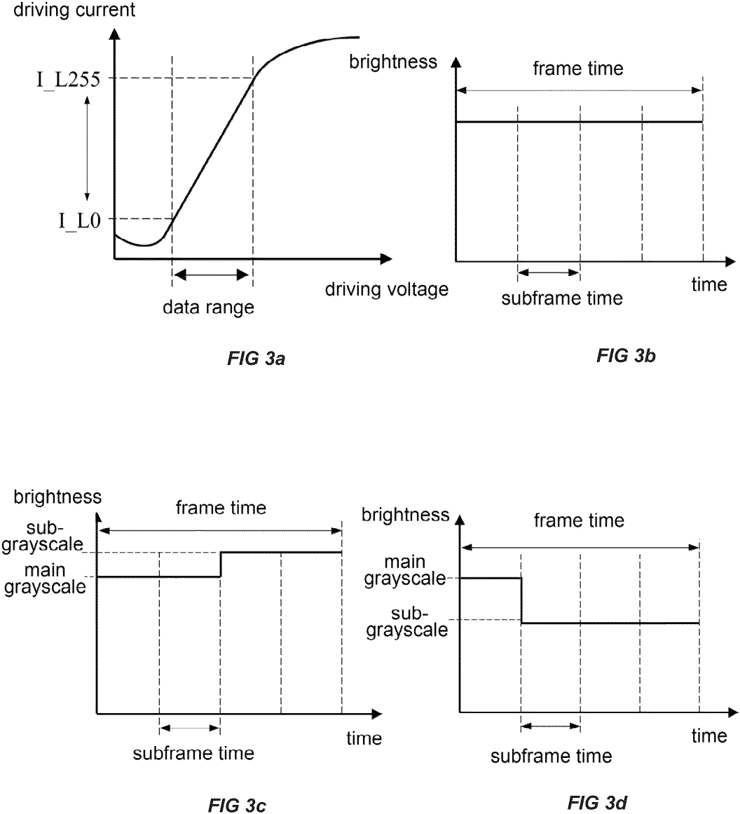

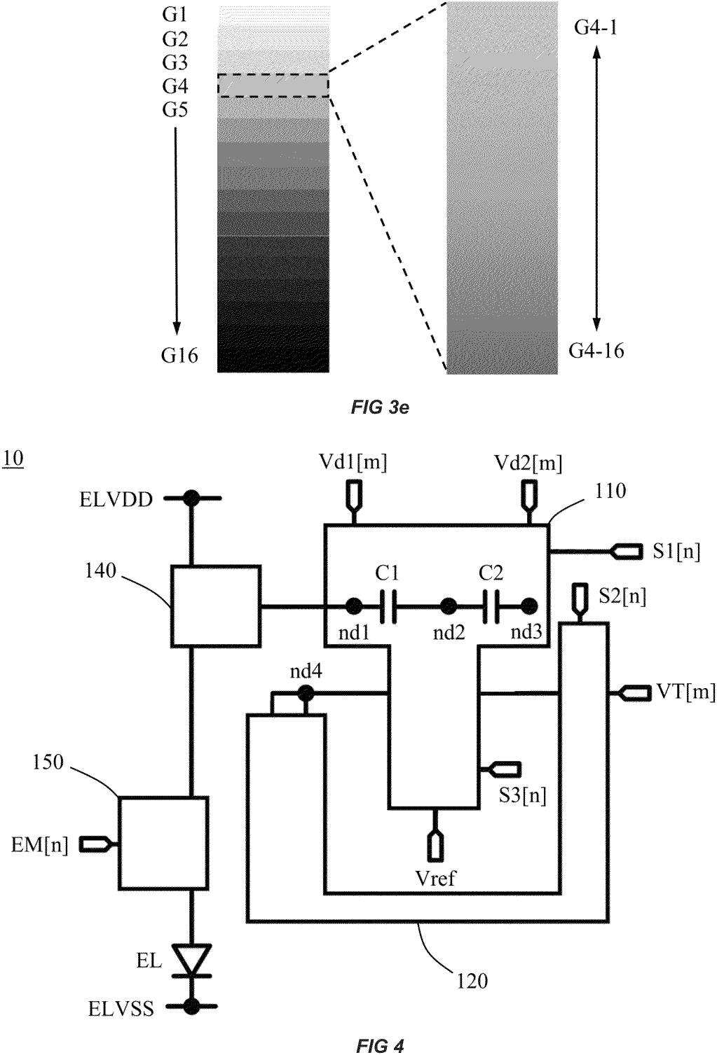

Reference now may be made to FIG. 1 to FIG. 3e, embodiments of the present disclosure provide a pixel circuit 10, which may be used in display device 1, for adjusting grayscales of an electroluminescent element EL in each pixel P in an active area A. Such grayscales may contain each grayscale at a bit depth, as well as a plurality of sub-grayscales of each grayscale itself. For example, in a grayscale mode with a bit depth of 8 bits, an image may have 2⁸, which is equal to 256, possible grayscale values. For traditional pixel circuit architectures (e.g., 2T1C), electroluminescent elements can be driven to emit light only with one of the 256 grayscale values in one frame time (as shown in FIG. 3a), and electroluminescent elements have to keep emitting light at same grayscale value in each subframe time of this frame time (as shown in FIG. 3b).

The pixel circuit 10 provided in the embodiment of the present disclosure may drive the electroluminescent element EL to emit light with one of these 256 possible grayscale values in the subframe time of the same frame time. The grayscale value at this time may be regarded as the main grayscale value of the current electroluminescent element EL. In the next subframe time, the electroluminescent element EL may be controlled to keep emitting light at the main grayscale value, or emit light with one grayscale value of the plurality of sub-grayscales based on this grayscale (as shown in FIGS. 3c to 3e), and then a fine-tuning operation to increase the main grayscale value (as shown in FIG. 3c) or decrease the main grayscale value (as shown in FIG. 3d) may be conducted.

For example, in a grayscale mode with a bit depth of 4 bits, an image may have 2⁴, which is equal to 16, possible grayscale values (as shown in FIG. 3e). In one subframe time of one frame time, the electroluminescent element EL may be driven to emit light by using one of these 16 grayscales G1~G16 as a first grayscale, for example, the electroluminescent element EL may be driven to emit light with the value of grayscale G4 to present a first grayscale image. Then, in the next subframe time of the same frame time, a sub-grayscale of the grayscale G4 itself may be selected as a second grayscale by switching data voltage, to drive the electroluminescent element to emit light. That is, with the hardware architecture unchanged, there are also 16 possible sub-grayscales G4-1-G4-16 between the up-next grayscale G3 and the down-next grayscale G5, which are next to the grayscale G4 upwards and downwards respectively. In the other word, the grayscale G3 is a previous grayscale of the grayscale G4 and the grayscale G5 is a next grayscale of the grayscale G4. And the electroluminescent element EL may be driven to emit light by using one of these 16 sub-grayscales G4-1-G4-16 as the second grayscale, so as to present a second grayscale image more like the realistic image.

Similarly, in some embodiments of the present disclosure, in a grayscale mode with a bit depth of 8 bits, an image may have 2⁸, which is equal to 256, possible grayscale values. The electroluminescent element EL may be adjusted in one subframe time of one frame time to emit light with one of these grayscale values as the first grayscale value. Then, at the same bit depth (i.e., 8 bits), the first grayscale itself also has 2⁸, which is equal to 256, possible sub-grayscales between the up-next grayscale and the down-next grayscale, which are next to the first grayscale upwards and downwards respectively. Therefore, the electroluminescent element may be adjusted to emit light with one of these sub-grayscale values of the first grayscale value itself as the second grayscale value in the next subframe time.

Therefore, in other embodiments of the present disclosure, with the hardware architecture unchanged, as the number of subframes increases, a grayscale mode equivalent to a grayscale mode at a higher bit depth may be provided for the luminescent element to emit light. For example, in a grayscale mode with a bit depth of 8 bits, switching of 2⁸, which is equal to 256, grayscale values may be conducted on the first data voltage and the second data voltage in 2², which is equal to 4, subframes, since each subframe has 256 grayscale values for selection and thus a grayscale mode equivalent to a grayscal mode at a bit depth of 10 bits may be provided, so that the image presented by the electroluminescent element EL after being adjusted has one of 2¹⁰, which is equal to 1024, possible grayscale values.

Reference now is made to FIG. 1, FIG. 2, and FIG. 4. In an embodiment of the present disclosure, the display device 1 may be, but not limited to, LED, micro LED and OLED displays or microdisplays, etc., and may include a backplane B and a display panel D disposed on the backplane B, and a plurality of pixels P may be arranged in a matrix arrangement on the display panel D, the pixles P may be arranged in N rows × M columns, and N and M are natural numbers. Furthermore, an electroluminescent element EL corresponding to each pixel P and a pixel circuit 10 coupled to the electroluminescent elements EL may be provided on the backplane B. The electroluminescent element EL and the pixel circuit 10 are electrically disposed on the substrate of the backplane B, and fall in the projection region of the corresponding pixel P in the projection direction.

In addition, the display device 1 may include a gate driver, a source driver, and a power driver. The gate driver provides control signals to pixels in N columns via N signal lines S1[n], S2[n], S3[n], EM[n]. The source driver supplies the data voltage and time voltage to one selected pixel P of pixels in M rows via M data lines Vd1[m], Vd2[m], VT[m]. Furthermore, the power driver provides a first power supply PW1 and a second power supply PW2 to the active area A, for example, provides a first voltage ELVDD and a second voltage ELVSS (as shown in FIG. 4) to the active area, and a DC bias source provides a reference voltage Vref, such as a ground voltage, to the active area A. In one embodiment, the first voltage ELVDD may be about 5 volts (5 V), the second voltage ELVSS may be about -5 V, and the reference voltage Vref may be about 0 V.

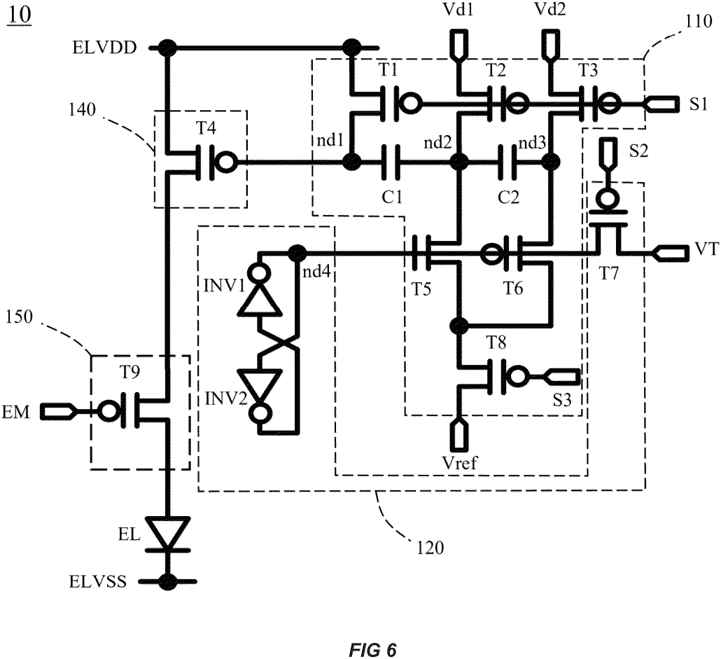

Reference now is made to FIG. 2, FIG. 4, and FIG. 6. The pixel circuit 10 provided by embodiments of the present disclosure may include a data selecting circuit 110, a latch circuit 120 and a function circuit 130. The data selecting circuit 110 may be configured to receive a first data voltage Vd1 and a second data voltage Vd2 in response to a first control signal S1, and applies the first data voltage Vd1 to a first node nd1 or a second node nd2, and applies the second data voltage Vd2 to a third node nd3. The data selecting circuit 110 may be further configured to receive a reference voltage Vref in response to a third control signal S3; and selectively transmit the reference voltage Vref to the second node nd2, in response to a time voltage VT of a fourth node nd4, for example, in response to a first time voltage, so as to generate a first grayscale signal corresponding to the first data voltage Vd1 at the first node nd1 according to a change of a voltage of the second node nd2; or transmit the reference voltage Vref to the third node nd3 in response to a second time voltage, so as to generate a second grayscale signal corresponding to the second data voltage Vd2 at the first node nd1 according to a change of a voltage of the third node nd3.

The latch circuit 120 is coupled to a fourth node nd4 and configured to receive and transmit a time voltage VT to the data selecting circuit 110 in response to the first control signal S1 and/or a second control signal S2; and configured to maintain a voltage value of the time voltage VT for a time period. For example, in some embodiments of the present disclosure, the fourth node ND4 may be coupled to the second node nd2 and the third node nd3 in the data selecting circuit 110, respectively. The latch circuit 120 may be configured to receive a first voltage ELVDD in response to the first control signal S1 in a first time stage, and apply the first voltage ELVDD to the fourth node nd4 by using the first voltage ELVDD as the first time voltage of the time voltage VT, and receive and transmit the second time voltage of the time voltage VT to the fourth node nd4 in a second time stage.

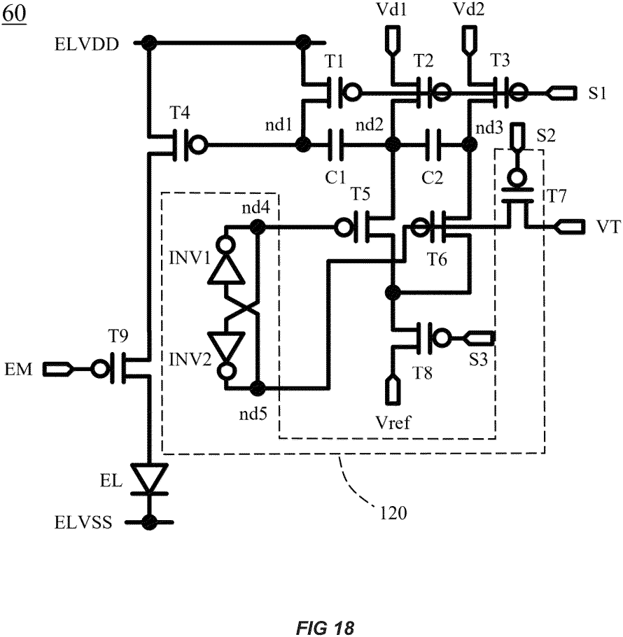

Alternatively, in certain embodiments of the present disclosure, the latch circuit 120 may receive and transmit the first time voltage of the time voltage VT to the fourth node nd4 at the first time stage, and receive and transmit the second time voltage to the fourth node nd4 at the second time stage. Alternatively, in other embodiments of the present disclosure, the fourth node nd4 may be coupled to the second node nd2 in the data selecting circuit 110, and there is further a fifth node nd5 coupled between the third node nd3 of the data selecting circuit 110 and the latch circuit 120 (as shown in FIG. 18). The latch circuit 120 may receive and transmit the first time voltage to the fourth node nd4 at the first time stage, and maintains the voltage level of the fourth node nd4, and receive and transmit the second time voltage to the fifth node nd5 at the second time stage, and maintains the voltage level of the fifth node nd5. The above are merely exemplary for describing the present disclosure, and the present disclosure is not limited thereto.

As shown in FIGS. 2 and 4, in embodiments of the present disclosure, the function circuit 130 may, but not limited to, include a driving circuit 140 and a switching circuit 150. The driving circuit 140 may be coupled to the first node nd1 in the data selecting circuit 110, and configured to transmit a first light-emitting signal to the switching circuit 150 in response to a first grayscale signal; and transmit a second light-emitting signal to the switching circuit 150 in response to a second grayscale signal. The switching circuit 150 is coupled between the driving circuit 140 and the electroluminescent element EL, and configured to transmit the first light-emitting signal and the second light-emitting signal to the electroluminescent element EL in response to a light-emitting control signal EM, so that the electroluminescent element EL displays a first grayscale image under the control of the first light-emitting signal, and displays a second grayscale image under the control of the second light-emitting signal.

Therefore, the pixel circuit 10 provided in the embodiments of the present disclosure establishes different data voltages Vd1, Vd2 in the data selecting circuit 110, and with the driving of latch circuit 120 by providing a time voltage VT at different time stages, the driving circuit 140 may generate light-emitting signals corresponding to various greyscale signals, and by the transmission of the switching circuit 150, the electroluminescent element EL may be driven to emit light with the first grayscale at the first time stage; and on the basis of the first grayscale, to emit light with a finer second grayscale at the second time stage. Particularly, the first and second time stages may be, but are not limited to, frame time of consecutive frames.

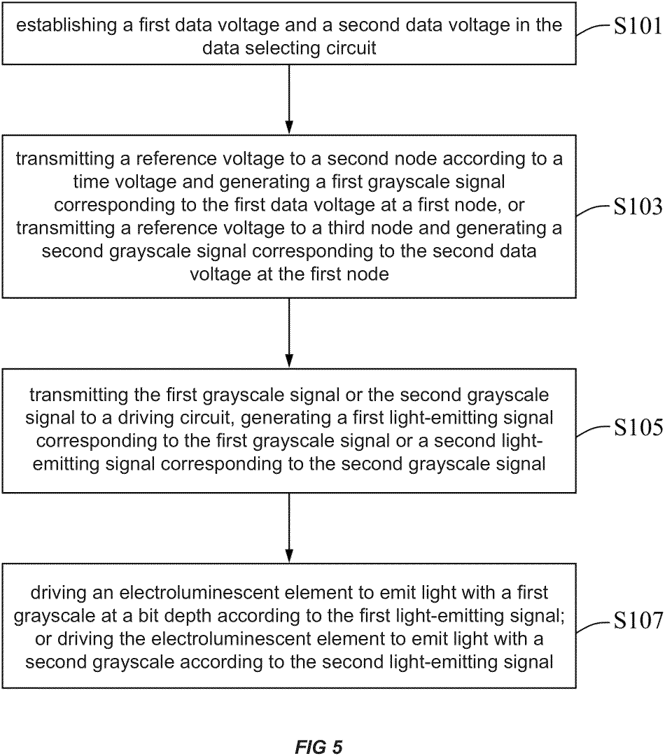

Reference is made to FIGS. 4 and 5, as stated above, in the embodiments of the present disclosure, the operation of the pixel circuit may generally include: establishing a first data voltage Vd1 and a second data voltage Vd2 in the data selecting circuit 110 (S101). For example, in some embodiments of the present disclosure, a first data voltage Vd1 is established at the second node nd2 in the data selecting circuit 110, and a second data voltage Vd2 is established at a third node nd3. In other embodiments of the present disclosure, a first data voltage Vd1 may be established at the first node nd1 in the data selecting circuit 110, and a second data voltage Vd2 may be established at a third node nd3.

Then, the reference voltage Vref is transmitted to the second node nd2 according to the time voltage VT, and the first grayscale signal corresponding to the first data voltage Vd1 is generated at the first node nd1, or the reference voltage Vref is transmitted to the third node nd3, and the second grayscale signal corresponding to the second data voltage Vd2 is generated at the first node nd1 (S103). In this step, the latch circuit 120 receives and transmits the first time voltage VT to the fourth node nd4 at the first time stage, so as to maintain the voltage level of the fourth node nd4 at the first time voltage. More particularly, a first capacitor C1 and a second capacitor C2 connected in series may be electrically provided in the data selecting circuit 110.

The first capacitor C1 is coupled between the first node nd1 and the second node nd2 to store the voltage of the first node nd1 and the second node nd2, and to maintain the voltage difference between the first node nd1 and the second node nd2. The second capacitor C2 is coupled between the second node nd2 and the third node nd3 to store the voltage of the second node nd2 and the third node nd3, and to maintain the voltage difference between the second node nd2 and the third node nd3. Therefore, when the voltage level of the second node nd2 or the third node nd3 changes, the voltage level of the first node nd1 will be changed correspondingly along with the second node nd2 or the third node nd3, and then the corresponding first grayscale signal and the second grayscale signal are generated at the first node nd1.

Then, a first grayscale signal or a second grayscale signal may be transmitted to the driving circuit 140, a first light-emitting signal corresponding to the first grayscale signal or a second light-emitting signal corresponding to the second grayscale signal is generated (S105). Particularly, the driving circuit 140 may be in response to the first grayscale signal or the second grayscale signal, and turn on corresponding transistor to conduct current, generate a corresponding light-emitting signal. Then, the electroluminescent element EL is driven according to the first light-emitting signal to emit light with a first grayscale; or the electroluminescent element EL is driven according to the second light-emitting signal to emit light with a second grayscale (S107). In this step, the switching circuit 150 may turn on corresponding transistor according to a light-emitting control signal received at different time, the first light-emitting signal and the second light-emitting signal may be transmitted to the electroluminescent element EL, so that the electroluminescent element EL emits light at grayscale corresponding thereto. For example, the first light-emitting signal is transmitted to the electroluminescent element EL at the first time stage, so that the electroluminescent element EL emits light with the first grayscale; and a second luminescence signal is transmitted at the second time stage, so that the electroluminescent element EL emits light with the second grayscale.

During the above operation, since the first time stage and the second time stage may be consecutive frame times, and the second grayscale is one of a plurality of sub- grayscales between the first grayscale and the up-next grayscale or the down-next grayscale upwards or downwards next to the first grayscale based on the first grayscale. Therefore, the pixel circuit 10 may perform grayscale switching in a relatively small data range, presenting a finer display quality, which is more like the realistic image, solving the mixing problem of grayscales caused by grayscale switching in too small data range.

As shown in FIG. 6, specifically, in one embodiment of the present disclosure, the data selecting circuit 110 includes a first capacitor C1 and a second capacitor C2. The first capacitor C1 is connected in series between the first node nd1 and the second node nd2 to store the voltage of the first node nd1 and the voltage of the second node nd2, and change the voltage level of the first node nd1 according to the change of the voltage of the second node nd2, so that a corresponding first grayscale signal is generated at the first node nd1. The second capacitor C2 is connected in series between the second node nd2 and the third node nd3 to store the voltage of the second node nd2 and the voltage of the third node nd3, and changes the voltage level of the second node nd2 and the first node nd1 according to the change of the voltage of the third node nd3, so that a corresponding second grayscale signal is generated at the first node nd1.

Furthermore, the data selecting circuit 110 further includes a first transistor T1, a second transistor T2, a third transistor T3, a fifth transistor T5, a sixth transistor T6 and an eighth transistor T8. It may be understood that the description of first, second, and so on added before the transistors in embodiments of the present disclosure are only for the convenience of explaining and understanding the content of the embodiments of the present disclosure, and are not intended to indicate the number of transistors included in this circuit. Furthermore, the transistor described in an embodiments of the present disclosure may be, but is not limited to, a field-effect transistor (FET). And, each of the transistors includes a metal-oxide-semiconductor (MOS) transistor or a thin-film transistor (TFT). In the present embodiment, the first transistor T1, the second transistor T2, the third transistor T3, the sixth transistor T6 and the eighth transistor T8 of the data selecting circuit 110 are p-type metal-oxide-semiconductor (PMOS) transistors, and the fifth transistor T5 is an n-type metal-oxide-semiconductor (NMOS) transistor.

More particularly, the gate electrode of the first transistor T1 is coupled to a first signal line to receive the first control signal S1; a first terminal is coupled to the first node nd1 located at one end of the first capacitor C1; and a second terminal is configured to receive a first voltage ELVDD, such as about 5 volts (V). One skilled in the art may understand that the first terminal of the MOS transistor may be a source electrode, the second terminal may be a drain electrode, and the source and drain are interchangeable, depending on the voltage applied thereto.

The gate electrode of the second transistor T2 is coupled to the first signal line to receive the first control signal S1; a first terminal is coupled to a second node nd2 located between the first capacitor C1 and the second capacitor C2; and a second terminal is coupled to a first data line, to receive the first data voltage Vd1.

The gate electrode of the third transistor T3 is coupled to the first signal line to receive the first control signal S1; a first terminal is coupled to a third node nd3 located at the other end of the second capacitor C2; and a second terminal is coupled to a second data line, to receive the second data voltage Vd2.

The gate electrode of the fifth transistor T5 is coupled to a fourth node nd4 located at one end of the latch circuit 120; a first terminal is coupled to the eighth transistor T8; and a second terminal is coupled to the second node nd2.

The gate electrode of the sixth transistor T6 is coupled to the fourth node nd4; a first terminal is coupled to the eighth transistor T8; and a second terminal is coupled to the third node nd3.

The gate electrode of the eighth transistor T8 is coupled to the third signal line to receive the third control signal S3; a first terminal is configured to receive a reference voltage Vref, such as ground voltage; and a second terminal is coupled to the fifth transistor T5 and the sixth transistor T6, respectively.

In some embodiments of the present disclosure, the latch circuit 120 includes a seventh transistor T7 and a set of back-to-back inverters. The gate electrode of the seventh transistor T7 is coupled to the second signal line to receive the second control signal S2; a first terminal is coupled to the fourth node nd4; and a second terminal is configured to receive a time voltage VT. The set of back-to-back inverters is coupled to the fourth node nd4, and includes a first inverter INV1 and a second inverter INV2 coupled to each other and configured to maintain the voltage level of the fourth node nd4 in the current state, e.g., maintain the voltage level of the fourth node nd4 at a voltage level at the first time stage, to turn on the fifth transistor T5 of the data selecting circuit 110; and maintain the voltage level of the fourth node nd4 at another corresponding voltage level at a next time stage to turn on the sixth transistor T6 of the data selecting circuit 110.

Particularly, a first output of the first inverter INV1 is coupled to a second input of the second inverter INV2, and a second output of the second inverter INV2 is coupled to a first input of the first inverter INV1. Thus, in the present embodiment, the fourth node nd4 is located on one side near the first output of the first inverter INV1, so that the first terminal of the seventh transistor T7 is coupled to the first output of the first inverter INV1. In another embodiment of the present disclosure, the fourth node nd4 may also be located on one side close to the second output of the second inverter INV2 (so that the first terminal of the seventh transistor T7 is coupled to the second output of the second inverter INV2), and may also be used to maintain the voltage level of the fourth node nd4.

The driving circuit 140 includes a fourth transistor T4, the gate electrode of which is coupled to the first node nd1; a first terminal is coupled to the switch circuit 150; and a second terminal is coupled to the first power supply, and configured to receive the first voltage ELVDD. In the present embodiment, the fourth transistor T4 may be used as a driving transistor, which may drive the electroluminescent element EL according to the voltage level of the first node nd1 (i.e., the data in the first capacitor C1).

The switching circuit 150 includes a ninth transistor T9, the gate electrode of which is configured to receive a light-emitting control signal EM; a first terminal is coupled to the anode of the electroluminescent element EL (such as micro LED, OLED or AMOLED, etc.); and a second terminal is coupled to the fourth transistor T4. Particularly, the cathode of the electroluminescent element EL is coupled to a second power supply and configured to receive a second voltage ELVSS.

Further explanation is made on the operations of the pixel circuit of the present disclosure by the embodiments of method below.

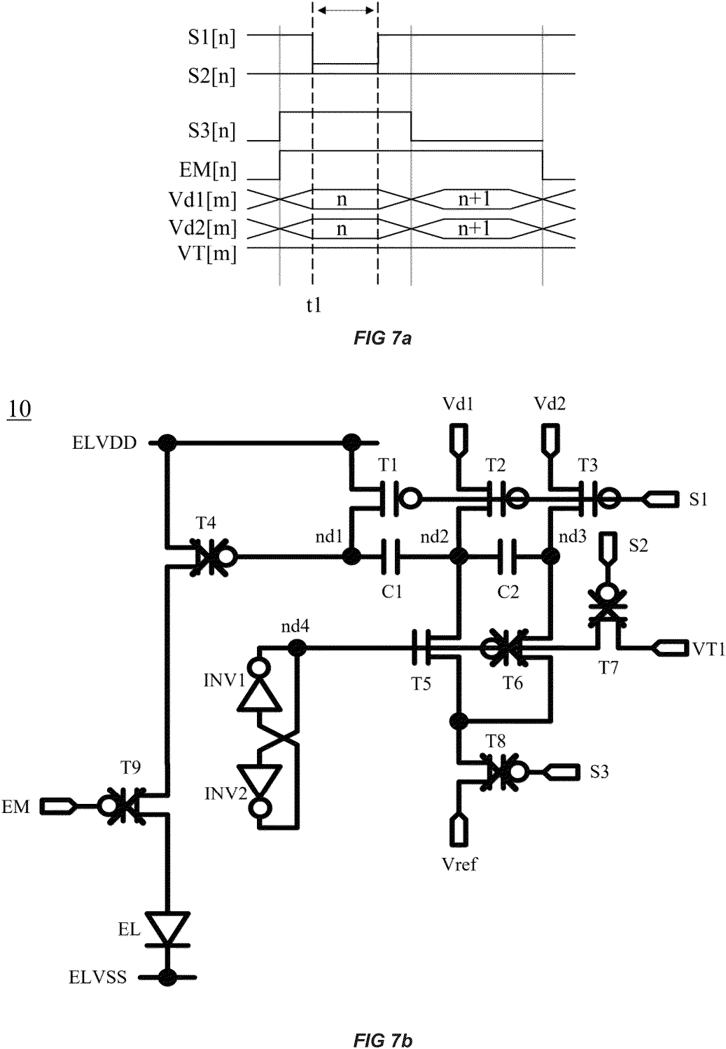

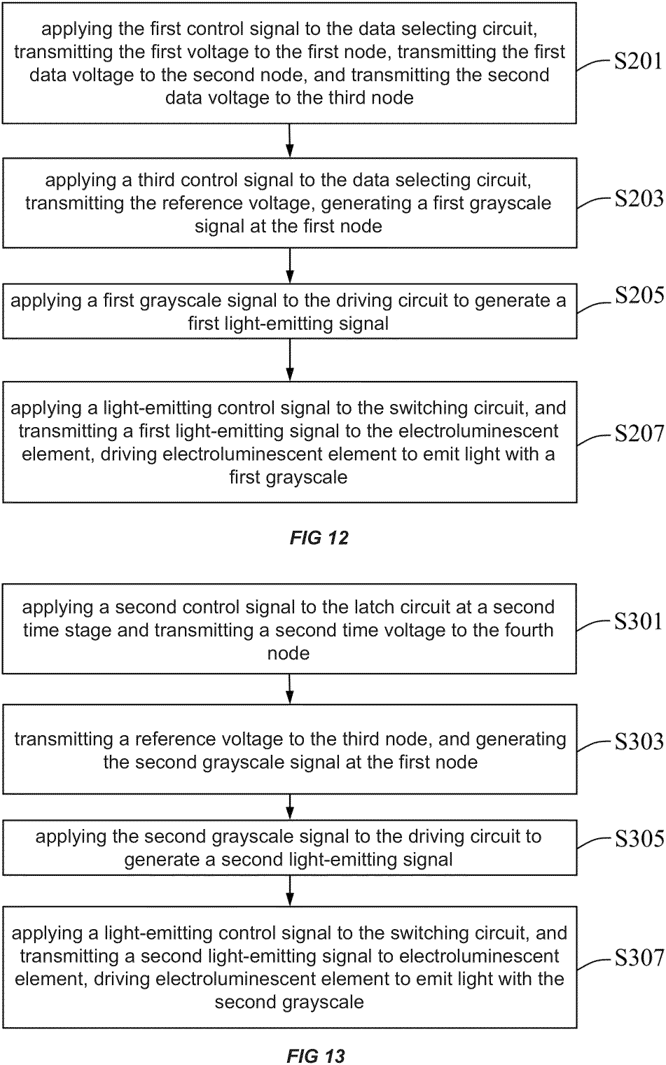

Reference is made to FIG. 6, FIG. 7a, FIG. 7b, and FIG. 12. The driving method of a pixel circuit 10 provided by an embodiment of the present disclosure may be used to control the grayscale of the electroluminescent element EL. First, a first control signal S1 is applied to the data selecting circuit 110, and a first voltage ELVDD is transmitted to the first node nd1, a first data voltage Vd1 is transmitted to the second node nd2, and a second data voltage Vd2 is transmitted to the third node nd3 (S201).

At the first time stage, for example, when the pixel is under the operation period of a subframe of one frame time, the first control signal S1, the second control signal S2, the third control signal S3 and the light-emitting control signal EM are set to be of the type of negative edge trigger. At time t1, the first control signal S1 is deasserted to the negative edge (falling edge), while the second control signal S2, the third control signal S3 and the light-emitting control signal EM at the high logical level are not deasserted. At this time, the first transistor T1 to the fifth transistor T5 are turned on, while the sixth transistor T6 to the ninth transistor T9 are turned off (labeled with symbol of “X” in the drawing). Since the first transistor T1, the second transistor T2 and the third transistor T3 are turned on, the voltage level of the first node nd1 is applied as the first voltage ELVDD, and the voltage level of the second node nd2 (labeled as Va hereinafter) is applied as the first data voltage Vd1; and the voltage level of the third node nd3 (labeled as Vb hereinafter) is applied as the second data voltage, Vd2. Since the gate electrode of the fourth transistor T4 is coupled to the first node nd1, the voltage level (labeled as Vg4 hereinafter) of the gate electrode of the fourth transistor T4 is set to the first voltage ELVDD at time t1.

With the first voltage ELVDD is a constant voltage, Vg4 is asserted to the first voltage ELVDD (Vg4=ELVDD), the fourth transistor T4 is turned off and the first voltage ELVDD is used as the power supply. At this time, Va is asserted to the first data voltage Vd1 (Va=Vdl_n) and Vb is asserted to the second data voltage Vd2 (Vb=Vd2_n). And Vg4 and Va are stored by the first capacitor C1, so that Vg4 is kept at the first voltage ELVDD and Va is kept at the first data voltage Vd1; and Va and Vb are stored by the second capacitor C2, so that Va is kept at the first data voltage Vd1, Vb is kept at the second data voltage Vd2, and the grayscale voltage that controls the grayscale of the pixel may be used to perform data addressing on the first capacitor C1 and the second capacitor C2. Therefore, the time period of time T1 may also be referred as a data addressing stage. At the same time, since the fifth transistor T5 is turned on, the data selecting circuit may select the first data voltage Vd1 as the grayscale voltage. Particularly, the gate electrode of the fifth transistor T5 and the gate electrode of the sixth transistor T6 are coupled to the fourth node nd4, respectively, so the voltage level of the fourth node nd4 (labeled as Vc hereinafter) may be used as a basis for selecting grayscale voltage.

In an embodiment of the present disclosure, at the first time stage, the second control signal S2 is deasserted to the negative edge, the seventh transistor T7 is turned on, a first time voltage VT1 is applied to the fourth node nd4, and Vc is maintained at the first time voltage VT1 by the set of back-to-back inverters, and the first data voltage Vd1 is used as the grayscale voltage by the fifth transistor T5.

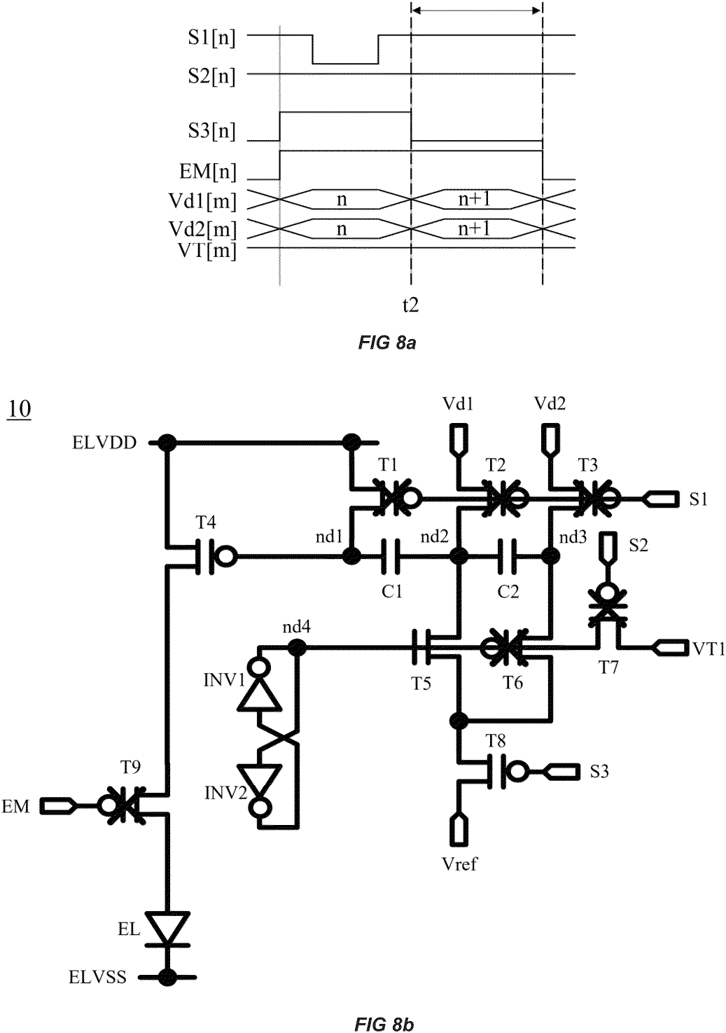

Reference is made to FIGS. 8a, 8b, and 12. Then, a third control signal S3 is applied to the data selecting circuit and a reference voltage Vref is transmitted, the first grayscale signal is generated at the first node nd1 (S203).

At time t2 (its time period may be regarded as the main grayscale loading stage), the third control signal S3 is deasserted to the negative edge, while the first control signal S1, the second control signal S2 and the light-emitting control signal EM at the high logic level are not deasserted. At this time, the fourth transistor T4 and eighth transistor T8 are turned on, while the first transistor T1 through the third transistor T3, the sixth transistor T6, the seventh transistor T7, and the ninth transistor T9 are turned off. At this time, since the fifth transistor T5 remains on, and the fourth transistor T4 and the eighth transistor T8 are turned on, the data may be written to the first capacitor C1 by the fifth transistor T5 and the eighth transistor T8, so that the reference voltage Vref is applied to the second node nd2, and then Va changes to the reference voltage Vref (Va = Vref), and Vg4 and Vb are changed at the same time.

Vg4 may be expressed by the following equation (1).

$$\text{Vg4= ELVDD-Vd1\_n+Vref} \qquad \text{Equation (1)}$$

Vb may be expressed by the following equation (2).

$$\text{Vb= Vd2\_n-Vd1\_n+Vref} \qquad \text{Equation(2)}$$

During this process, since Vc remains unchanged, the operation result of the last step may be maintained. Moreover, due to the change of Vg4, the first grayscale signal is generated at the first node nd1 correspondingly. At this time, since the fourth transistor T4 of the driving circuit is turned on, the first grayscale signal is applied to the driving circuit to generate the first light-emitting signal (S205), and the first light-emitting signal corresponds to the first grayscale of the electroluminescent element EL.

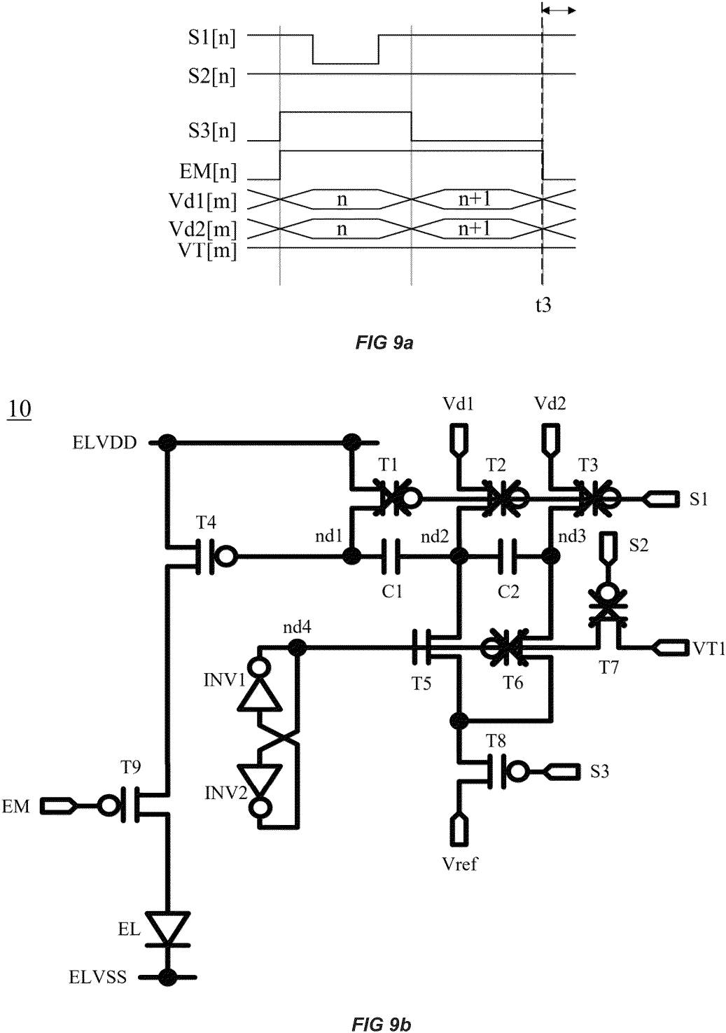

Reference is made to FIGS. 9a, 9b, and 12. After that, a light-emitting control signal is applied to the switching circuit, and the first light-emitting signal is transmitted to the electroluminescent element EL, to drive the electroluminescent element EL to emit light with the first grayscale (S207). At time t3, the light-emitting control signal EM is deasserted to the negative edge, while the first control signal S1 and the second control signal S2 at the high logic level are not deasserted. In this way, the ninth transistor T9 of the switching circuit is turned on. During this time, the fourth transistor T4, fifth transistor T5, and eighth transistor T8 remain on, since Vg4 is ELVDD-Vd1_n+Vref, Vb is Vd2_n-Vd1_n+Vref, Va is Vref, and Vc is approximately ELVDD (or VT1).

At this time, the current from the first voltage (ELVDD) terminal as the power supply flows through the electroluminescent element EL by means of the fourth transistor T4 and arrives at the second voltage (ELVSS) terminal, to drive the electroluminescent element EL to emit light with the first grayscale. For example, in a grayscale mode with a bit depth of 8 bits, the image has 2⁸, which is equal to 256, possible grayscale values, which define the main grayscale values of the electroluminescent element EL and the electroluminescent element EL emits light with one of the 256 grayscale values as the first grayscale. Therefore, the time period of time t3 is the stage during which the electroluminescent element EL emits light with the main grayscale. The generated current may be expressed by the following equation.

$$\begin{matrix}\left|\text{Id}\right| = \frac{1}{2} \times μ \times {\text{C}}_{\text{ox}} \times {\left(\text{ELVDD-} \left(\text{ELVDD-Vd1\_n+Vref}\right) - \left|\text{Vth}\right|\right)}^{2} = \\ \frac{1}{2} \times μ \times {\text{C}}_{\text{ox}} \times {\left(\text{Vd1\_n-Vref-} \left|\text{Vth}\right|\right)}^{2}\end{matrix}$$

Wherein, Id is a current flowing through the electroluminescent element EL; Vth is a threshold voltage; µ is mobility; Cox is the gate capacitor.

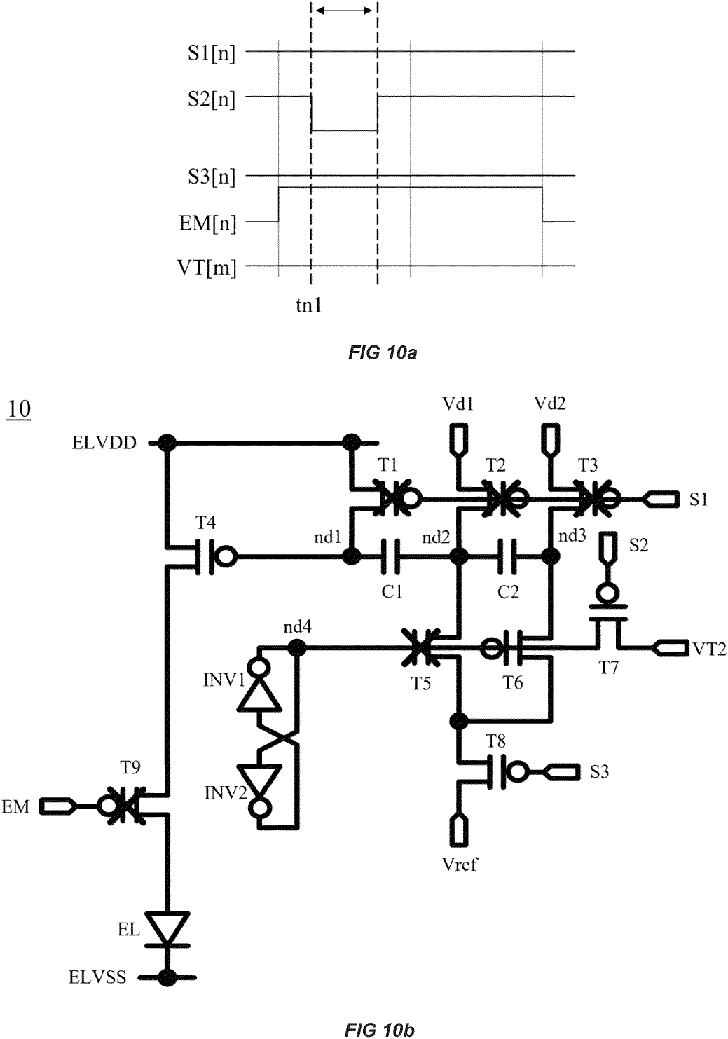

Reference is made to FIGS. 10a, 10b, and 13. THen, a second control signal is applied to the latch circuit at the second time stage, and a second time voltage is transmitted to the fourth node (S301).

During the operating period of the next subframe of the same frame time, at time tn1, the second control signal S2 is deasserted to the negative edge, while the first control signal S1 and the light-emitting control signal EM at high logical level are not deasserted. At this time, the first transistor T1 to the third transistor T3, the fifth transistor T5, and the ninth transistor T9 are turned off, the sixth transistor T6 is turned on, and Vc is pulled to a low voltage level (Vc=low voltage). Therefore, the seventh transistor T7 of the latch circuit is turned on under the selected subframe, the data path is switched, and operations of addition and subtraction may be performed on the grayscale value. In an embodiment of the present disclosure, the time period of time tn1 is used as the arithmetic grayscale loading stage. Particularly, since the fourth transistor T4 and the eighth transistor T8 remain on, and the sixth transistor T6 and the seventh transistor T7 are turned on, a second time voltage VT2 may be applied to the fourth node nd4 by the seventh transistor T7, and Vc may be maintained at the second time voltage VT2 by the latch circuit; and the second data voltage Vd2 is used as the grayscale voltage via the sixth transistor T6.

At the same time, the reference voltage Vref is transmitted to the third node nd3 through the sixth transistor T6 and the eighth transistor T8, and a second grayscale signal is generated at the first node nd1 (S303). Particularly, the sixth transistor T6 and the eighth transistor T8 write data to the second capacitor C2, so that the reference voltage Vref is applied to the third node nd3, to change Vb to the reference voltage Vref (Vb = Vref), and change Vg4 and Va at the same time.

Vg4 may be expressed by the following equation (3).

$$\text{Vg4= ELVDD-Vd2\_n+Vref} \qquad \text{Equation (3)}$$

Va may be expressed by the following equation (4).

$$\text{Va} = \text{Vref-Vd2\_n-Vd1\_n} \qquad \text{Equation (4)}$$

At the same time, since the fourth transistor T4 remains on, a second grayscale signal is applied to the driving circuit to generate a second light-emitting signal (S305).

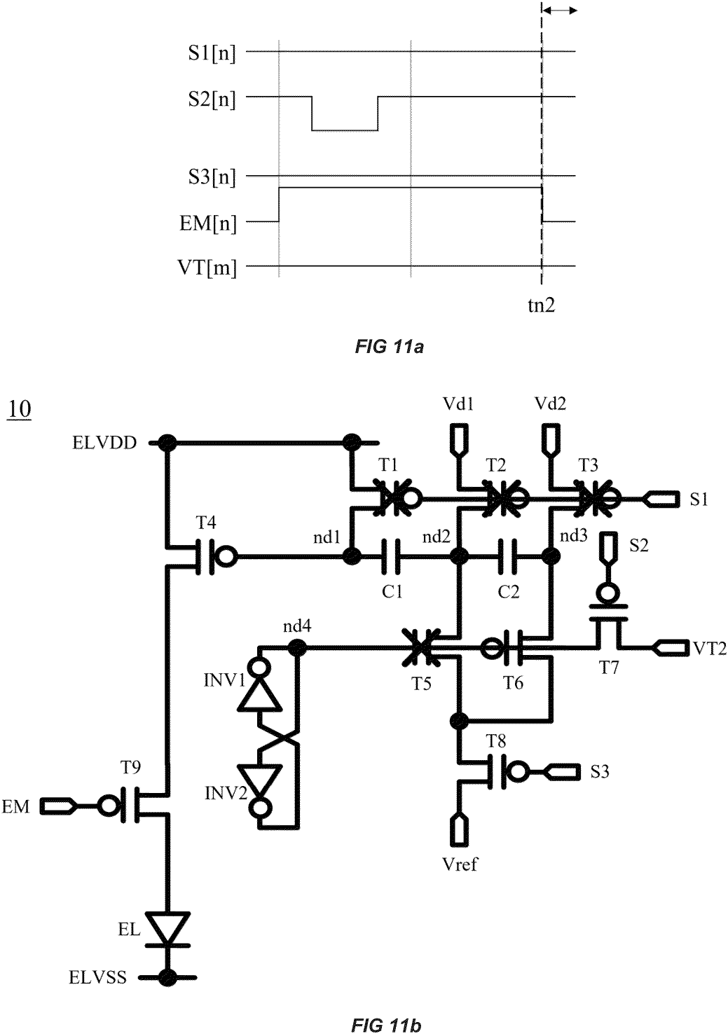

Reference is made to FIGS. 11a, 11b, and 13. Then, a light-emitting control signal is applied to the switching circuit, and a second light-emitting signal is transmitted to the electroluminescent element EL, to drive the electroluminescent element EL to emit light with the second grayscale (S307).

At time tn2, the light-emitting control signal EM is pulled to the negative edge, while the first control signal S1 at the high logical level is not pulled. In this way, the ninth transistor T9 is turned on. In the time period of time tn2, since Vg4 remains ELVDD-Vd2_n+Vref, Va remains Vref-Vd2_n-Vd_nl, Vb is Vref, and Vc maintains at a low voltage, the fourth transistor T4 and the sixth transistor T6 to the ninth transistor T9 remain on. At this time, the current from the first voltage (ELVDD) terminal as the power supply flows through the electroluminescent element EL by means of the fourth transistor T4 and arrives at the second voltage (ELVSS) terminal, to drive the electroluminescent element EL to emit light with one of a plurality of sub-grayscales of the first grayscale as the second grayscale. The generated current may be expressed by equation (5) below.

$$\left|\text{Id}\right| = \frac{1}{2} \times μ \times {\text{C}}_{\text{ox}} \times {\left(\text{Vd2\_n-Vref-} \left|\text{Vth}\right|\right)}^{2} \qquad \text{Equation (5)}$$

Since in an embodiment of the present disclosure, a frame includes four subframes, and a switching on the first data voltage Vd1 and the second data voltage Vd2 of 2⁸, which is equal to 256, grayscale values may be performed by means of these four subframes, so that the image may be under the operation of 2¹⁰, which is equal to 1024, possible grayscale values like in the grayscale mode at a bit depth of 10 bits, so as to define the increasing and decreasing of the main grayscale value of the electroluminescent element EL accordingly, and an Arithmetic Grayscale driving method, which may be regarded as increasing the bit depth to achieve the function of adjusting the main grayscale of the electroluminescent element EL. Therefore, the pixel circuit 10 provided in the embodiment of the present disclosure may present the pixel at a realistic grayscale and improve the display quality and the mixing problem of grayscales by means of an analog driving method combined with an arithmetic grayscale driving method on the timeline.

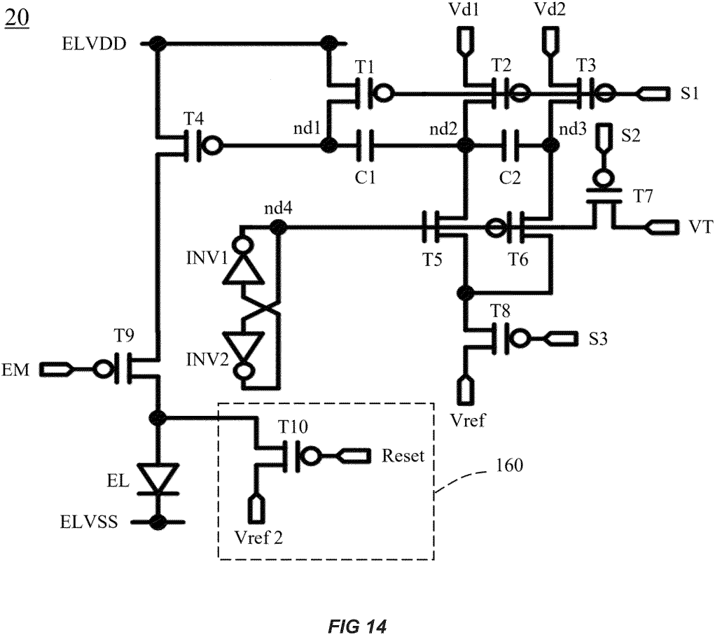

Reference is made to FIG. 14. The pixel circuit 20 provided in another embodiment of the present disclosure is similar to the pixel circuit 10 shown in an embodiment of FIG. 6, except that it further includes a reset circuit 160, which is coupled between the switching circuit and the electroluminescent element EL, and is configured to transmit a second reference voltage Vref2 to the electroluminescent element EL in response to a reset signal Reset to reset the electroluminescent element EL. Specifically, the reset circuit 160 includes a tenth transistor T10, which includes a gate electrode configured to be in response to the reset signal Reset; a first terminal configured to receive a second reference voltage Vref2; and a second terminal coupled between the switching circuit and the electroluminescent element EL, e.g., coupled to a node between the switching circuit and the electroluminescent element EL. The tenth transistor t10 turns on in response to the reset signal Reset, and apply a second reference voltage Vref2 to this node to reset the voltage level of the electroluminescent element EL, so that the grayscale of the electroluminescent element EL is reset to the initial state or the default value.

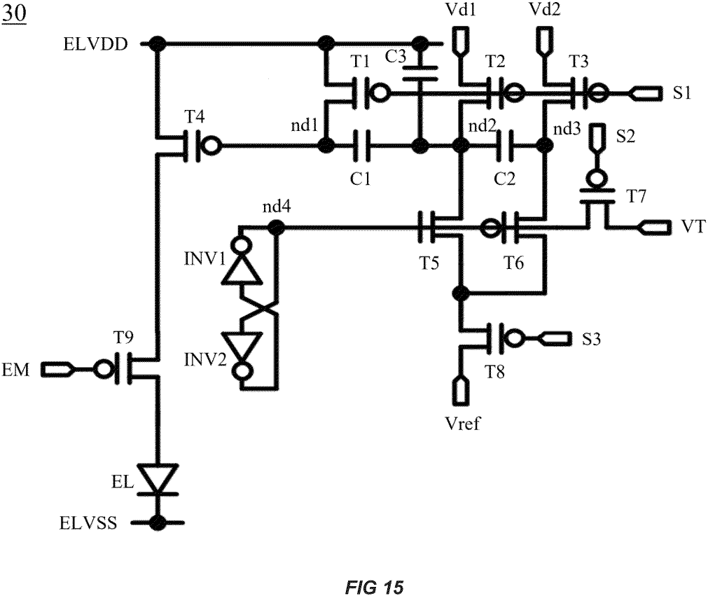

Reference is made to FIG. 15. Some embodiments of the present disclosure provide a pixel circuit 30 similar to the pixel circuit 10 shown in an embodiment of FIG. 6, except that the data selecting circuit thereof further includes a third capacitor C3, one end of which is configured to receive a first voltage ELVDD, and the other end is coupled to a node between the first capacitor C1 and the second capacitor C2 to stabilize the voltage of the first node nd1 in the grayscale voltage selection operation.

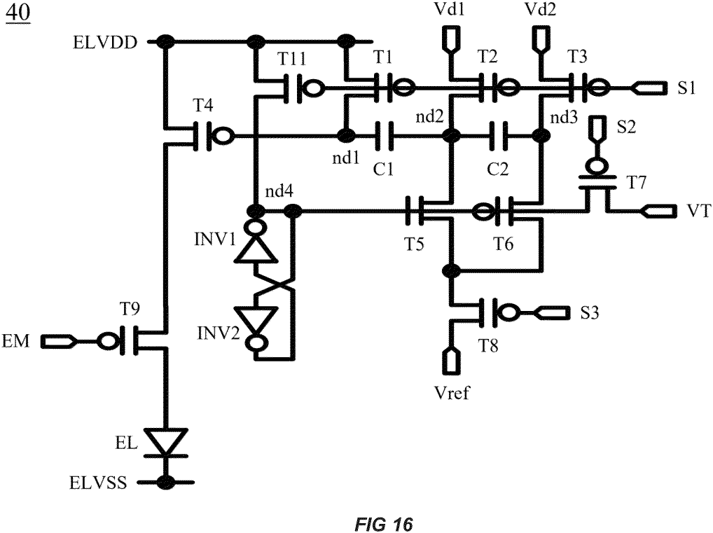

Reference is made to FIG. 16. The pixel circuit 40 provided in other embodiments of the present disclosure is similar to the pixel circuit 10 shown in the embodiment of FIG. 6, except that in the present embodiment, the latch circuit is configured to apply the first voltage ELVDD to the fourth node nd4 in response to the first control signal S1. For example, the first voltage ELVDD is applied to the fourth node nd4 according to the first control signal S1 at the first time stage, and with the first voltage ELVDD as the first time voltage, the data selecting circuit 110 selectively turn on the second node nd2 according to the first voltage ELVDD, so that the reference voltage Vref is applied to the second node nd2, and a first grayscale signal is generated at the first node nd1. This first grayscale signal corresponds to the first grayscal of the electroluminescent element EL; and at a second time stage, a time voltage VT is applied to the fourth node nd4 according to the second control signal S2, and with the time voltage VT as the second time voltage, the data selecting circuit selectively turns on the third node nd3 according to the time voltage VT, so that the reference voltage Vref is applied to the third node nd3, and the second grayscale signal is generated at the first node nd1 correspondingly. This second grayscale signal corresponds to the second grayscale of the electroluminescent element EL.

Specifically, in addition to the seventh transistor T7 and the set of back-to-back inverters (the first inverter INV1 and the second inverter INV2), the latch circuit 120 further includes an eleventh transistor T11. The gate electrode of the eleventh transistor T11 is coupled to the first signal line to receive the first control signal S1; a first terminal is coupled to the fourth node nd4; and a second terminal is configured to receive the first voltage ELVDD. Thus, the eleventh transistor T11 may transmit the first voltage ELVDD to the fourth node nd4 in response to the first control signal S1.

Particularly, the latch circuit 120 applys the first voltage ELVDD to the fourth node nd4 in response to the first control signal S1 at the first time stage by the eleventh transistor, so that the fifth transistor T5 of the data selecting circuit 110 coupled to the fourth node nd4 may conduct the second node nd2 according to the first voltage ELVDD, and the reference voltage Vref is applied to the second node nd2, thereby a first grayscale signal is generated at the first node nd1. Further, at the second time stage, the latch circuit may apply a time voltage VT to the fourth node nd4 by the seventh transistor T7 in response to the second control signal S2, so that the sixth transistor T6 of the data selecting circuit 110 coupled to the fourth node nd4 may conduct the third node nd3 according to the time voltage VT, and the reference voltage Vref is applied to the third node nd3, thereby a second grayscale signal is generated at the first node nd1.

Therefore, in the operation of the pixel circuit 40 of the embodiment described in FIG. 16 above, the first control signal S1 may be applied to the latch circuit at the first time stage, the eleventh transistor T11 is turned on, so that the first voltage ELVDD is transmitted to the fourth node nd4. And, under the control of the first inverter INV1 and the second inverter INV2, the fourth node nd4 is maintained at the voltage level of the first voltage ELVDD. At this time, the latch circuit may apply the first voltage ELVDD as the first time voltage to the fifth transistor T5 of the data selecting circuit, and transmit the reference voltage Vref to the second node nd2 to generate the first grayscale signal at the first node nd1. In the subsequent second time stage, a second control signal S2 is applied to the latch circuit, and the 7th transistor T7 is turned on, so that the time voltage VT is transmitted to the fourth node nd4. Moreover, with this time voltage VT as the second time voltage, under the control of the first inverter INV1 and the second inverter INV2, the voltage level of the fourth node nd4 is maintained at the voltage level of the second time voltage. Thus, at the second time stage, the latch circuit 120 may apply a second time voltage to the sixth transistor T6 of the data selecting circuit, and the reference voltage Vref is transmitted to the third node nd3, so that the second grayscale signal is generated at the first node nd1.

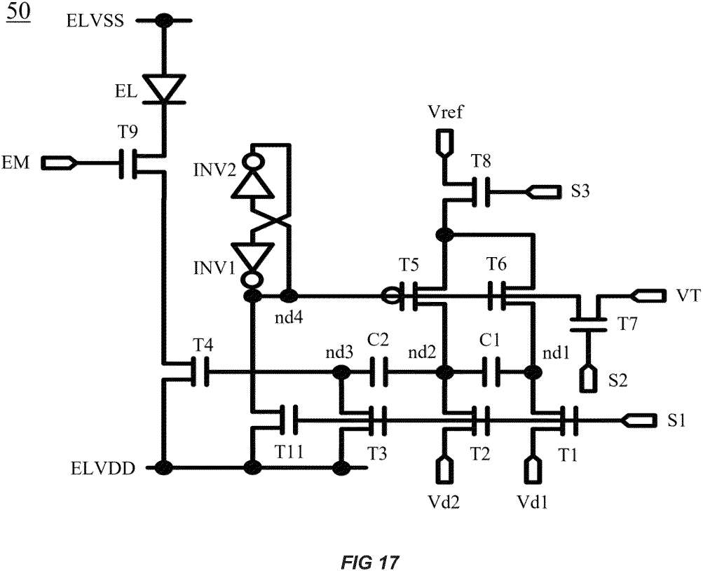

Reference is made to FIG. 17, which is a circuit diagram of the equivalent circuit of the pixel circuit 10 shown in FIG. 16. The pixel circuit 50 shown in the embodiment of FIG. 17 is similar to the pixel circuit 40 shown in the embodiment of FIG. 16, except that n- type TFT or NMOS transistors are used as the first transistor T1 to the fourth transistor T4 and the sixth transistor T6 to the eleventh transistor T11 instead of the p-type TFT or PMOS transistor in FIG. 16; and a p-type TFT or PMOS transistor is used as the fifth transistor T5, instead of the n-type TFT or NMOS transistor in FIG. 16.

Reference is made to FIG. 18. The pixel circuit 60 provided by some embodiments of the present disclosure is similar to the pixel circuit 10 shown in an embodiment of FIG. 6, except that the first transistor T1 to the ninth transistor T9 are transistors of the same type, for example, all are p-type metal-oxide-semiconductor transistors. In the latch circuit 120, the first output of the first inverter INV1 of the set of back-to-back inverters is coupled to the fourth node nd4, and is coupled to the gate electrode of the fifth transistor T5 of the data selecting circuit through the fourth node nd4; and the second output of the second inverter INV2 is coupled to the fifth node nd5 and coupled to the gate electrode of the sixth transistor T6 of the data selecting circuit through the fifth node nd5. Thus, when the latch circuit 120 responds to the second control signal S2 at different time stages through the seventh transistor T7, and receives the corresponding first time voltage and second time voltage in the time voltage VT, the first time voltage may be established at the fourth node nd4 and the second time voltage may be established at the fifth node nd5, respectively. And under the control of the first inverter INV1 and the second inverter INV2, the voltage level of the fourth node nd4 and the fifth node nd5 is maintained.

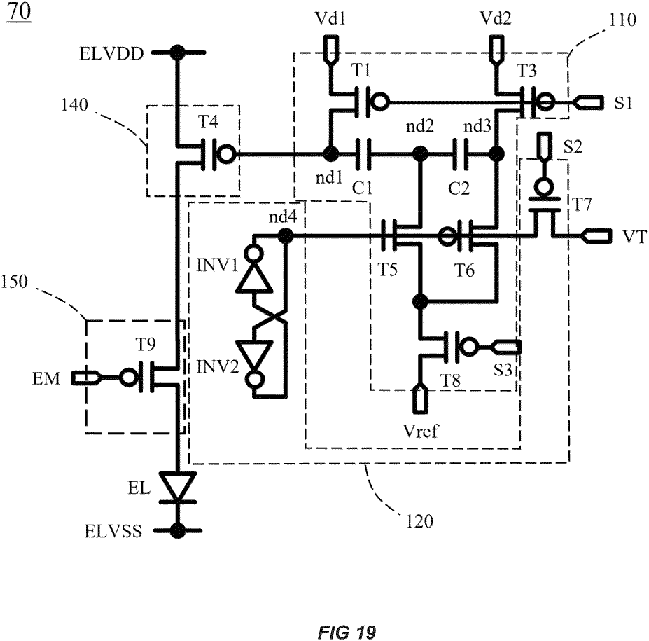

Reference is made to FIG. 19. A pixel circuit 70 provided by one embodiment of the present disclosure may include a data selecting circuit 110, a latch circuit 120, a driving circuit 140 and a switching circuit 150. It differs from the pixel circuit 10 shown in an embodiment of FIG. 6 in that the data selecting circuit 110 omits the setting of the second transistor. Specifically, in the pixel circuit 70 of the present embodiment, the data selecting circuit 110 includes a first transistor T1, a third transistor T3, a fifth transistor T5, a sixth transistor T6 and an eighth transistor T8. Particularly, the first transistor T1, the third transistor T3, the sixth transistor T6 and the eighth transistor T8 are p-type metal-oxide-semiconductor transistors, and the fifth transistor T5 is an n-type metal-oxide-semiconductor transistor.

The gate electrode of the first transistor T1 is coupled to a first signal line to receive the first control signal S1; the first terminal is coupled to the first node nd1 located at one end of the first capacitor C1; and the second terminal is coupled to the first data line, and configured to receive the first data voltage Vd1. In addition, the second node nd2 between the first capacitor C1 and the second capacitor C2 is coupled among the first capacitor C1, the second capacitor C2, and the fifth transistor T5.

Therefore, in the driving method of the pixel circuit 70, establishing the data voltage is mainly in applying the first control signal S1 to the data selecting circuit 110, turning on the first transistor T1 to receive and transmit the first data voltage Vd1 to the first node nd1; and turning on the third transistor T3 to receive and transmit the second data voltage Vd2 to the third node nd3. In addition, establishing the reference voltage Vref of the second node nd2 is in applying the control signal S3 to the data selecting circuit 110 to turn on the eighth transistor T8 to receive the reference voltage Vref, and transmitting the reference voltage Vref to the second node nd2 through the fifth transistor T5. Therefore, in the initial state, the first data voltage Vd1 is established at the first node nd1, the reference voltage Vref is established at the second node nd2, and the second data voltage Vd2 is established at the third node nd3. And the potential difference between the first node nd1 and the second node nd2 is maintained by the first capacitor C1; and the potential difference between the second node nd2 and the third node nd3 is maintained by the seconds capacitor C2. In subsequent operations, the data selecting circuit 110 may control the voltage level of the fourth node nd4 according to the latch circuit 120, so that the data selecting circuit 110 may turn on the fifth transistor T5 according to the voltage level of the fourth node nd4, and transmit the reference voltage Vref to the second node nd2 to generate the first grayscale signal accordingly; or turn on the sixth transistor T6 and transmit the reference voltage Vref to the third node nd3 to generate a second grayscale signal accordingly, so as to facilitate the control on the grayscales of the electroluminescent element EL in subsequent operations.

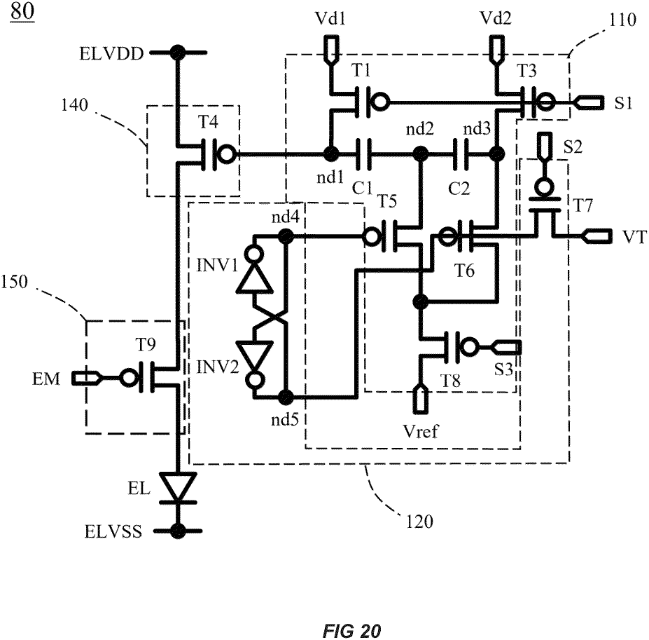

Reference is made to FIG. 20. A pixel circuit 80 provided by an embodiment of the present disclosure is similar to the pixel circuit 70 shown in FIG. 19, except that, in this pixel circuit 80, the first transistor T1 to the ninth transistor T9 are the same type of transistors, for example, all are p-type etal-oxide-semiconductor transistors. And in the latch circuit 120, the first output of the first inverter INV1 of the set of back-to-back inverters is coupled to the fourth node nd4, and is coupled to the gate electrode of the fifth transistor T5 of the data selecting circuit 110 through the fourth node nd4; and the second output of the second inverter INV2 is coupled to the fifth node nd5, and is coupled to the gate electrode of the sixth transistor T6 of the data selecting circuit 110 through the fifth node nd5.

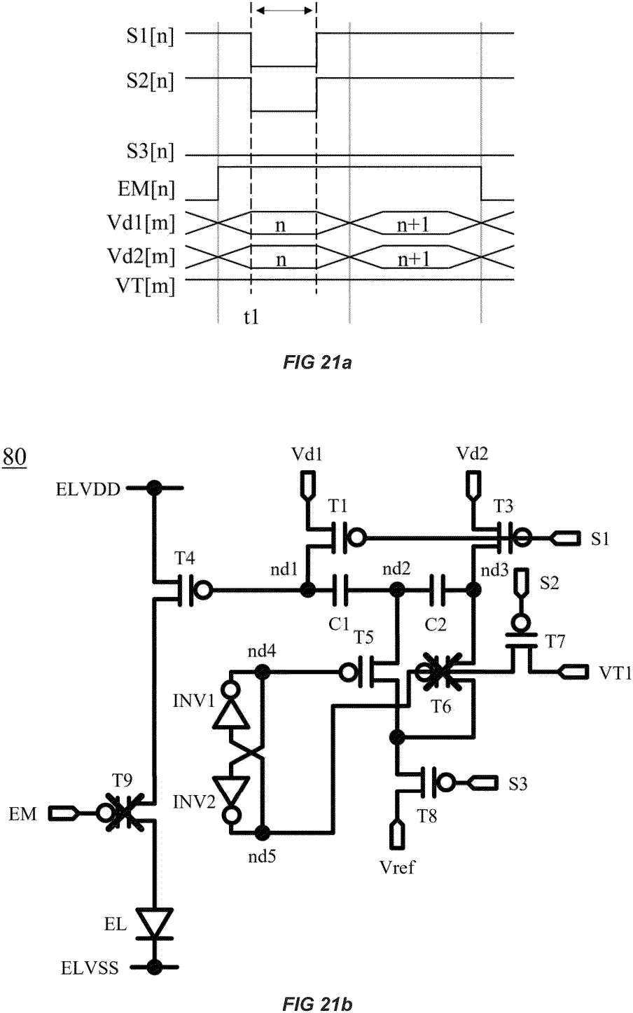

Reference is made to FIGS. 20, 21a, 21b, and FIG. 25. Thus, in the driving method of the pixel circuit of the present embodiment, firstly, the first control signal S1 is applied to the data selecting circuit 110, the first data voltage Vd1 is transmitted to the first node nd1 and the second data voltage Vd2 is transmitted to the third node nd3. Further, a third control signal S3 is applied to the latch circuit 120, the first time voltage VT1 is applied to the fourth node nd4 (S401).

At the first time stage, for example, when the pixel is in a subframe time of one frame time, the first control signal S1, the second control signal S2, the third control signal S3 and the light-emitting control signal EM are set to be of the type of negative edge trigger. At time t1, the first control signal S1 and the second control signal S2 are pulled to the negative edge, respectively, while the third control signal S3 and the luminescent control signal EM at a high logical level are not pulled. At this time, the sixth transistor T6 and the ninth transistor T9 are turned off (labeled with the symbol of “X” in the drawing), while the rest of the transistors are turned on. Since the first transistor T1, the third transistor T3, the fifth transistor T5 and the eighth transistor T8 are turned on, the voltage level of the first node nd1 is applied as the first data voltage Vd1, and the voltage level of the second node nd2 (labeled as Va hereinafter) is applied as the reference voltage Vref; and the voltage level of the third node nd3 (labeled as Vb hereinafter) is applied as the second data voltage Vd2. Since the gate electrode of the fourth transistor T4 is coupled to the first node nd1, the voltage level (labeled as Vg4 hereinafter) of the gate electrode of the fourth transistor T4 as the driving transistor is set to the first data voltage Vd1 (Vg4=Vd1_n) at time t1.

At this time, Va is asserted to the reference voltage Vref (Va=Vref) and Vb is asserted to the second data voltage Vd2 (Vb=Vd2_n). And, Vg4 is maintained at the first data voltage Vd1 and Va is maintained at the reference voltage Vref by storing Vg4 and Va in the first capacitor C1; and Va is maintained at the reference voltage Vref, Vb is maintained at the second data voltage Vd2 by storing Va and Vb in the second capacitor C2. The first data voltage Vd1 that controls the grayscale of the pixel may be used to perform data addressing on the first capacitor C1 and the fourth transistor T4; and the second data voltage Vd2 that controls the grayscale of the pixel may be used to perform data addressing on the first capacitor C1 and the second capacitor C2.

At the same time, since the second control signal S2 is pulled to the negative edge, the seventh transistor T7 is turned on, the first time voltage VT1 is applied to the fourth node nd4, and the voltage level of the fourth node nd4 (hereinafter labeled as Vc) is maintained at the low voltage level of the first time voltage VT1 through the set of back-to-back inverters, and the first time voltage VT1 is applied to the fifth transistor T5, so that the fifth transistor T5 is turned on, and the reference voltage Vref is transmitted to the second node nd2, so that the first data voltage Vd1 is selected as the grayscale voltage used to control the electroluminescent element EL at the first time stage.

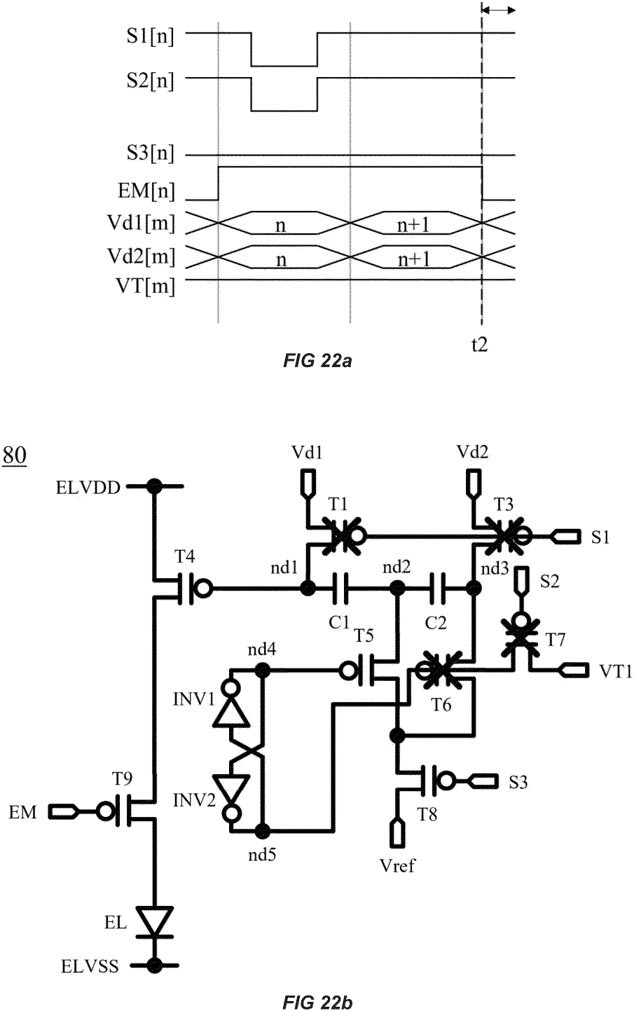

Reference is made to FIGS. 20, 22a, 22b, and 25. Then, the light-emitting control signal EM is applied to the switching circuit 150, and the first light-emitting signal is transmitted to the electroluminescent element EL, the electroluminescent element EL is driven to emit light with the first grayscale (S403).

At time t2, the light-emitting control signal EM is pulled to the negative edge, while the first control signal S1, the second control signal S2, and the third control signal S3 at the high logic level are not pulled. The first transistor T1, the third transistor T3, and the seventh transistor T7 are turned off, and the sixth transistor remains off. And, the ninth transistor T9 of the switching circuit 150 is turned on.

At this time, since Vg4 remains at Vd1_n, Va is Vref, Vb is Vref, and Vc is about Vd2_n, the fourth transistor T4, the fifth transistor T5, and the eighth transistor T8 remain on. Therefore, the current from the first voltage (ELVDD) terminal as the power supply flows through the electroluminescent element EL by the fourth transistor T4 and arrives at the second voltage (ELVSS) terminal, so that the electroluminescent element EL is driven to emit light with the first grayscale, and the main grayscale values of the electroluminescent element EL are defined accordingly. The generated current may be expressed by the following equation.

$$\left|\text{Id}\right| = \frac{1}{2} \times μ \times {\text{C}}_{\text{ox}} \times {\left(\text{ELVDD-Vd1\_n-} \left|\text{Vth}\right|\right)}^{2}$$

Particularly, in the operation of the next time stage, in order to switch the fifth transistor T5 and the sixth transistor T6 without signal interference, in some embodiments of the present disclosure, the voltage level of the third control signal S3 may be pulled at time t2, so that the eighth transistor T8 is turned off. Then, the operation of turning off the fifth transistor T5 and turning on the sixth transistor T6 is performed. And, after the switching of the fifth transistor T5 and the sixth transistor T6 is completed, the eighth transistor T8 is turned on to transmit the reference voltage Vref to the third node nd3 through the eighth transistor T8 and the sixth transistor T6.

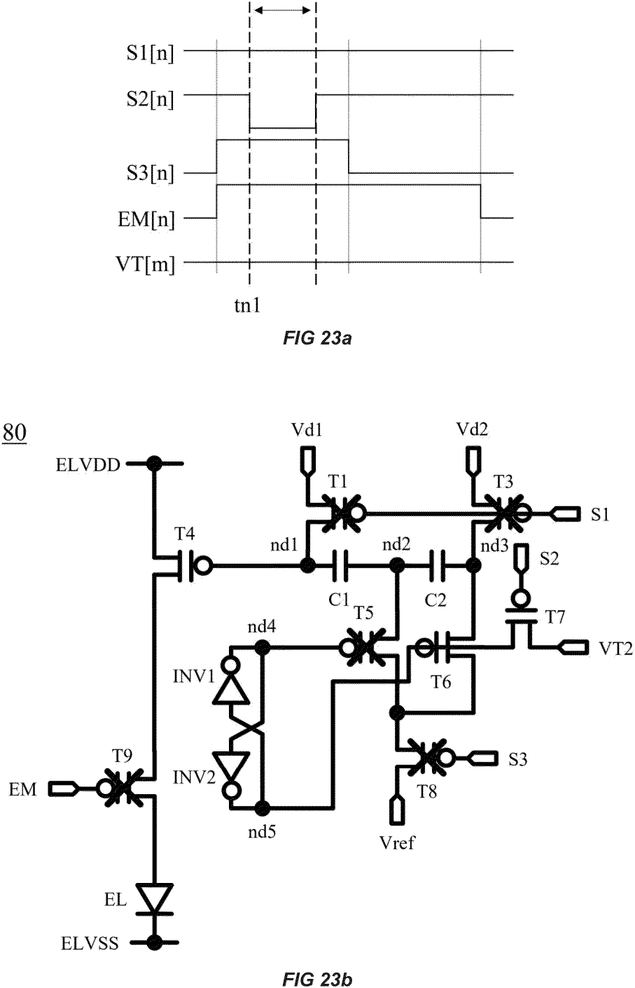

Reference is made to FIGS. 20, 23a, 23b, and 25. Then, a second control signal S2 is applied to the latch circuit 120 at the second time stage, and a second time voltage VT2 is transmitted to the fifth node nd5 (S405).

For example, in the next subframe time of the same frame time, at time tn1, the second control signal S2 is pulled to the negative edge, while the first control signal S1, the third control signal S3, and the light-emitting control signal EM at the high logic level are not pulled. At this time, the first transistor T1, the third transistor T3, the fifth transistor T5, and the ninth transistor T9 are turned off, while the sixth transistor T6 is turned on. Therefore, the data may be written to the second capacitor C2, so that the reference voltage Vref is applied to the third node nd3, and Vb changes to the reference voltage (Vb = Vref), and Va and Vg4 changes at the same time.

Vg4 may be expressed by the following equation (6).

$$\text{Vg4= Vd1\_n-Vd2\_n} \qquad \text{Equation (6)}$$

Va may be expressed by the following equation (7).

$$\text{Va = Vref-Vd2\_n} \qquad \text{Equation (7)}$$

At this time, the seventh transistor T7 of the latch circuit 120 is turned on under the selected subframe, and the data path is switched to perform operations of addition and subtraction on the main grayscale value. In an embodiment of the present disclosure, the time period of time tn1 is used as the arithmetic grayscale loading stage, and since the fourth transistor T4 remains on, and the sixth transistor T6 and the seventh transistor T7 are turned on, a second time voltage VT2 may be applied to the fifth node nd5 by the seventh transistor T7, and the voltage level of the fifth node nd5 is maintained at a low voltage level by latch circuit 120. At this stage, since the sixth transistor T6 remains on, a second data voltage Vd2 may be selected as the grayscale voltage by the sixth transistor T6. Moreover, with the change of the voltage level Vg4 of the first node nd1, a corresponding second grayscale signal is generated at the first node nd1.

Then, a second grayscale signal is applied to the drive circuit 140 to generate a second light-emitting signal (S407). Particularly, since the fourth transistor T4 is coupled to the first node nd4 and remains on, the gate electrode of the fourth transistor T4 responds to the second grayscale signal, and the second light-emitting signal is generated accordingly.

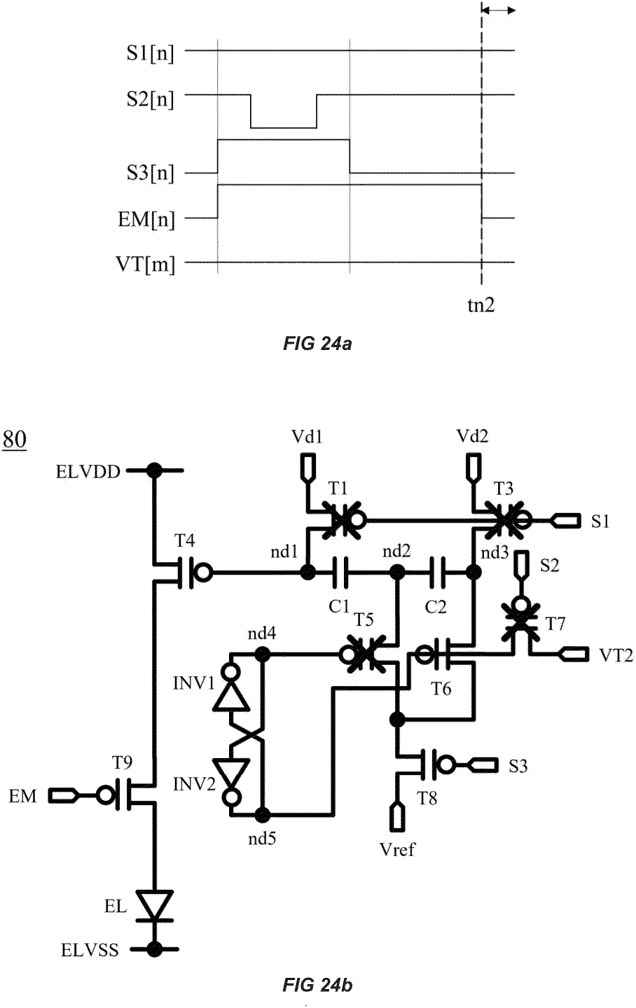

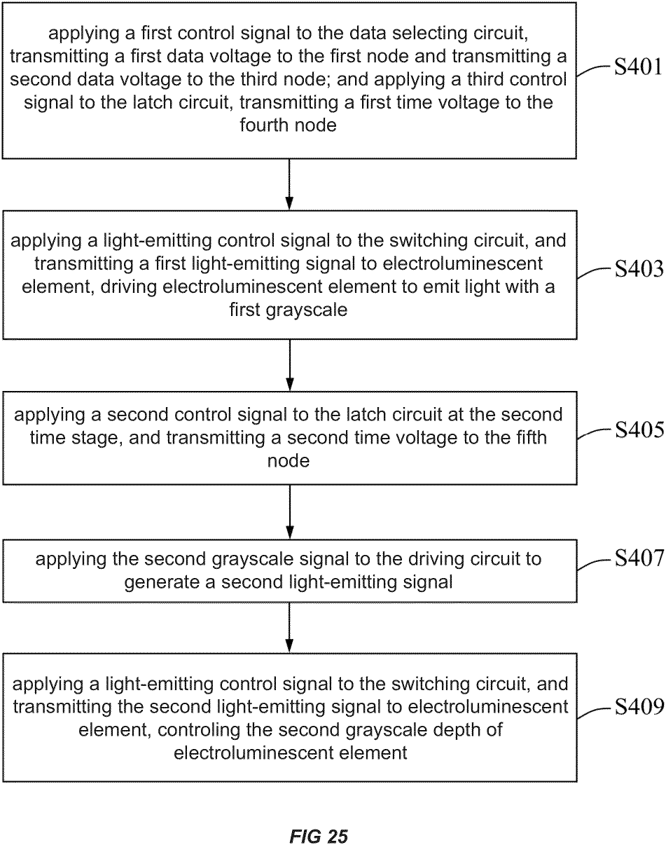

Reference is made to FIGS. 24a, 24b, and 25. After that, the light-emitting control signal is applied to the switching circuit 150, and a second light-emitting signal is transmitted to the electroluminescent element EL, the electroluminescent element EL is driven to emit light with a second grayscale (S409).

At the time tn2, the light-emitting control signal EM is pulled to the negative edge, while the first control signal S1 to the third control signal S3 at the high logic level are not pulled. In this way, the ninth transistor T9 is turned on. In the time period of time tn2, since Vg4, Va and Vb are unchanged, and Vc remains at the low voltage level, the fourth transistor T4, the sixth transistor T6, eighth transistor T8, and ninth transistor T9 remain on. At this time, the current from the first voltage (ELVDD) terminal as the power supply flows through the electroluminescent element EL by the fourth transistor T4 and arrives at the second voltage (ELVSS) terminal, so that the electroluminescent element EL is driven to emit light with the second grayscale. The generated current may be expressed by the following equation.

$$\left|\text{Id}\right| = \frac{1}{2} \times μ \times {\text{C}}_{\text{ox}} \times {\left(\text{ELVDD-Vd1\_n+Vd2\_n-} \left|\text{Vth}\right|\right)}^{2}$$

Thus, the pixel circuit provided by the embodiment of the present disclosure may be used to drive the electroluminescent element to emit light with the first grayscale at the first time stage, and with the switching of different time stages on the time axis, the frist grayscale is subdivided into a plurality of sub-grayscales on the basis of the first grayscale, so that the electroluminescent element emits light with one of them as the second grayscale at the second time stage, thereby improving the display quality to be more like the realistic color.

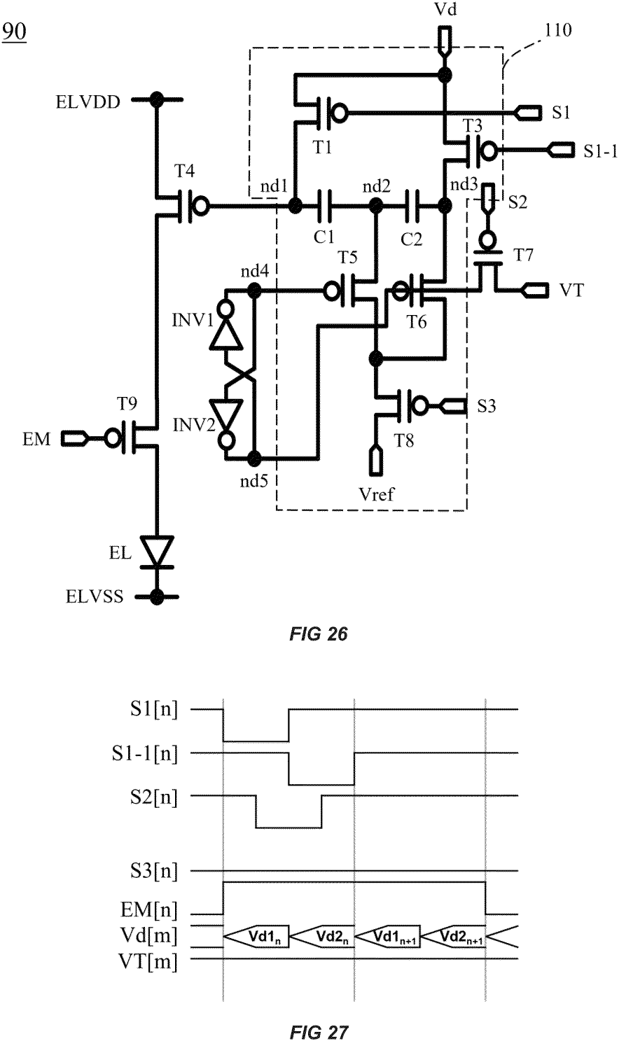

Reference is made to FIGS. 26 and 27. An embodiment of the present disclosure provides a pixel circuit 90, which is similar to the pixel circuit 80 shown in an embodiment of FIG. 20, except that the data selecting circuit 110 is further coupled to a data line to receive a data voltage Vd; and coupled to a first signal branch line to receive a first branch control signal S1-1 in addition to being coupled to a first signal line to receive the first control signal S1.

Specifically, the gate electrode of the first transistor T1 of the data selecting circuit 110 is coupled to the first signal line and configured to be in response to the first control signal S1; the first terminal is coupled to the data line, and configured to receive the data voltage Vd, and uses this data voltage Vd as the first data voltage; and the second terminal is coupled to the first node nd1. The gate electrode of the third transistor T3 of the data selecting circuit 110 is coupled to the first signal branch line and configured to be in response to the first branch control signal S1-1; the first terminal is coupled to the data line and is configured to receive the data voltage Vd, and the data voltage Vd is used as the second data voltage; and the second terminal is coupled to the third node nd3.

Thus, in this embodiment, the first control signal S1 may be first pulled to the negative edge at some time to apply the first control signal S1 to the first transistor T1 of the data selecting circuit 110, and turn on the first transistor T1 to receive the data voltage, and transmit the data voltage to the first node nd1 as the first data voltage, and the first data voltage is established at the first node nd1. Then, at another time, the first branch control signal S1-1 is pulled to the negative edge to apply the first branch control signal S1-1 to the third transistor T3 of the data selecting circuit 110, turn on the third transistor T3 to receive the data voltage, and transmit the data voltage to the third node nd3 as the second data voltage, and the second data voltage is established at the first node nd3. And, in the case that a reference voltage is established at the second node, the potential difference between the first node nd1 and the second node nd2 is maintained by storing the first data voltage and the reference voltage Vref by the first capacitor C1; and the potential difference between the second node nd2 and the third node nd3 is maintained by storing the reference voltage Vref and the second data voltage by the second capacitor C2. Therefore, The first data voltage that controls the grayscale of the pixel may be used to perform data addressing on the first capacitor C1 and the fourth transistor T4; and the second data voltage that controls the grayscale of the pixel may be used to perform data addressing on the first capacitor C1 and the second capacitor C2.

In summary, the pixel circuit of the embodiment of the present disclosure may perform grayscale switching in a relatively small data range, presenting a finer display quality, which is more like the realistic image, solving the mixing problem of grayscale caused by grayscale switching in too small data range. Further, although switching between the first grayscale and the second grayscale is illustrated as an exemplary example in the above embodiment, the pixel circuit provided in the embodiment of the present disclosure also has the characteristics of expanding as required. That is, with the capacitors and transistors added to the data selecting circuit, switching may be performed between main grayscales and more sub-grayscales and finer picture quality may be achieved.

For example, the first capacitor, second capacitor and third capacitor connected in series may be provided in the data selecting circuit, and the corresponding transistors may be additionally provided, so that the first data voltage that controls the grayscale of the pixel may be used to perform data addressing on the first capacitor and the fourth transistor; and the second data voltage that controls the grayscale of the pixel may be used to perform data addressing on the first capacitor and the second capacitor, and the third data voltage that controls the grayscale of the pixel may be used to perform data addressing on the second capacitor C2 and the third capacitor C3. Moreover, in subsequent operations, the electroluminescent element may be driven to emit light with the first grayscale, on the basis of the first grayscale, emit light with a finer second grayscale, and on the basis of the second grayscale, emit light with a much finer third grayscale, thereby the display quality may be improved.

Thus, in other embodiments of the present disclosure, the number of capacitors and transistors of the data selecting circuit may be extrapolated in a similar way to obtain a display quality more like the realistic image.

Characteristics of various embodiments summarized above are for better understanding of one skilled in the art on the present disclosure. One skilled in the art should understand that the present disclosure is convenient to be used as a basis of designing or modifying other processes and structures to implement the embodiments described in the present disclosure for same objects and/or achieve same advantages. One skilled in the art should also understand that such equivalent constructions are within the spirit and scope of the present disclosure, and various variations, modifications, alternatives can be made thereto without departing from the spirit and scope of the present disclosure.

1. A pixel circuit, characterized in being used to control grayscales of electroluminescent elements, the pixel circuit comprising:
a data selecting circuit configured to receive a first data voltage and a second data voltage, and selectively generate a first grayscale signal corresponding to the first data voltage and a second grayscale signal corresponding to the second data voltage according to a time voltage;
a latch circuit coupled to the data selecting circuit and configured to receive and transmit the time voltage;
a driving circuit coupled to the data selecting circuit, and configured to transmit a first light-emitting signal in response to the first grayscale signal and a second light-emitting signal in response to the second grayscale signal; and
a switching circuit respectively coupled to the driving circuit and the electroluminescent element, and configured to transmit the first light-emitting signal to the electroluminescent element, drive the electroluminescent element to emit light with a first grayscale of a bit depth, or transmit the second light-emitting signal to the electroluminescent element, drive the electroluminescent element to emit light with a second grayscale, wherein the second grayscale is one of a plurality of sub-grayscales between the first grayscale and a previous or next grayscale of the first grayscale at the bit depth.

2. The pixel circuit according to claim 1, wherein,
the data selecting circuit comprises a first capacitor coupled between a first node and a second node and a second capacitor coupled between the second node and a third node, the data selecting circuit is further configured to receive a reference voltage in response to a third control signal, and transmit the reference voltage to the second node or the third node in response to the time voltage, change a voltage level of the first node, and generate the first grayscale signal or the second grayscale signal correspondingly;
the latch circuit is further configured to transmit the time voltage to the data selecting circuit in response to a first control signal or a second control signal;
the driving circuit is coupled to the first node, and configured to transmit the first light-emitting signal in response to the first grayscale signal and transmit the second light-emitting signal in response to the second grayscale signal.

3. The pixel circuit according to claim 2, wherein the data selecting circuit is further configured to transmit the first data voltage to the first node or the second node and the second data voltage to the third node in response to the first control signal.

4. The pixel circuit according to claim 3, wherein the data selecting circuit further comprises:
a first transistor, coupled to the first node, and configured to transmit a first voltage or the first data voltage to the first node in response to the first control signal;
a third transistor, coupled to the third node, and configured to transmit the second data voltage to the third node in response to the first control signal;
a fifth transistor, coupled between the second node and the latch circuit, and configured to transmit the reference voltage to the second node in response to the time voltage;
a sixth transistor, coupled between the third node and the latch circuit, and configured to transmit the reference voltage to the third node in response to the time voltage; and
an eighth transistor, coupled to the fifth transistor and the sixth transistor respectively, and configured to transmit the reference voltage in response to the third control signal.

5. (canceled)

6. The pixel circuit according to claim 4, wherein the first terminal of the first transistor is configured to receive the first voltage, the first transistor is configured to transmit the first voltage to the first node in response to the first control signal, and the data selecting circuit further comprises a second transistor coupled to the second node, and configured to transmit the first data voltage to the second node in response to the first control signal.

7. (canceled)

8. The pixel circuit according to claim 4, wherein the fifth transistor is a first-type transistor, and the remaining transistors are second-type transistors.

9. The pixel circuit according to claim 2, wherein the data selecting circuit further comprises:
a third capacitor, one end of which is coupled to a DC voltage source, and the other end is coupled between the first capacitor and the second capacitor, and configured to stabilize a voltage level of the first node.

10. The pixel circuit according to claim 2, wherein the latch circuit further comprises:
a set of back-to-back inverters coupled to a fourth node, and the fourth node is coupled to the data selecting circuit, wherein the time voltage is applied to the fourth node, and the set of back-to-back inverters are configured to maintain a voltage level of the fourth node.

11. The pixel circuit according to claim 10, wherein the set of back-to-back inverters comprises:
a first inverter and a second inverter, a first output of the first inverter is coupled to a second input of the second inverter, and a second output of the second inverter is coupled to a first input of the first inverter, wherein the fourth node is located on a side near the first output or a side near the second output.

12. The pixel circuit according to claim 11, wherein the time voltage comprises:
a first time voltage and a second time voltage, the latch circuit is configured to transmit the first time voltage to the fourth node at a first time stage, and transmit the second time voltage to the fourth node at a second time stage, the data selecting circuit is configured to transmit the reference voltage to the second node in response to the first time voltage, and transmit the reference voltage to the third node in response to the second time voltage.

13. The pixel circuit according to claim 12, wherein the fourth node is located on a side close to the first output, and a fifth node is located on a side close to the second output, the first time voltage is applied to the fourth node, the second time voltage is applied to the fifth node, and the set of back-to-back inverters are further configured to maintain a voltage level of the fifth node.

14. The pixel circuit according to claim 13, wherein the latch circuit further comprises:
a seventh transistor coupled to the fourth node and/or the fifth node, and configured to transmit the first time voltage and/or the second time voltage in response to the second control signal.

15. The pixel circuit according to claim 14, wherein the latch circuit further comprises:
an eleventh transistor coupled to the fourth node, the eleventh transistor is configured to transmit the first time voltage to the fourth node in response to the first control signal, the seventh transistor is configured to transmit the second time voltage to the fourth node or the fifth node in response to the second control signal.

16. The pixel circuit according to claim 2, wherein
the driving circuit comprises:
a fourth transistor comprising a gate electrode coupled to the first node and configured to generate the first light-emitting signal in response to the first grayscale signal and generate the second light-emitting signal in response to the second grayscale signal; a first terminal configured to receive a first voltage; and a second terminal coupled to the switching circuit; and
the switching circuit comprises:
a ninth transistor comprising a gate electrode configured to transmit the first light-emitting signal and the second light-emitting signal in response to a light-emitting control signal; a first terminal coupled to the electroluminescent element; and a second terminal coupled to the driving circuit and configured to receive the first light-emitting signal and the second light-emitting signal.

17. (canceled)

18. The pixel circuit according to claim 2, further comprises:
a reset circuit having a tenth transistor coupled between the switching circuit and the electroluminescent element, and configured to transmit another reference voltage to the electroluminescent element in response to a reset signal, to reset a voltage level of the electroluminescent element.

19. (canceled)

20. The pixel circuit according to claim 3, wherein the data selecting circuit is coupled to a data line, a first signal line, and a first signal branch line, respectively, the data selecting circuit is configured to transmit the first data voltage of the data line to the first node or the second node in response to the first control signal of the first signal line, and transmit the second data voltage of the data line to the third node in response to a first branch control signal of the first signal branch line.

21. The pixel circuit according to claim 20, wherein the data selecting circuit further comprises:
a first transistor coupled to the first signal line and the first node respectively and configured to transmit the voltage or the first data voltage to the first node in response to the first control signal;
a third transistor coupled to the data line, the first signal branch line, and the third node, respectively, and configured to transmit the second data voltage to the third node in response to the first branch control signal;
a fifth transistor coupled between the second node and the latch circuit and configured to transmit the reference voltage to the second node in response to the time voltage;
a sixth transistor coupled between the third node and the latch circuit and configured to transmit the reference voltage to the third node in response to the time voltage; and
an eighth transistor coupled to the fifth transistor and the sixth transistor, respectively, and configured to transmit the reference voltage in response to the third control signal.

22. The pixel circuit of claim 21, wherein the data selecting circuit further comprises a second transistor, the first transistor is configured to transmit the first voltage to the first node in response to the first control signal, the second transistor is coupled to the data line, the first signal branch line, and the second node, respectively, and configured to transmit the first data voltage to the second node in response to the first branch control signal.

23. A backplane of a display device, comprises: a substrate and a pixel circuit disposed on the substrate, wherein the pixel circuit comprises:
a data selecting circuit configured to receive a first data voltage and a second data voltage, and selectively generate a first grayscale signal corresponding to the first data voltage and a second grayscale signal corresponding to the second data voltage according to a time voltage;
a latch circuit coupled to the data selecting circuit and configured to receive and transmit the time voltage;
a driving circuit coupled to the data selecting circuit, and configured to transmit a first light-emitting signal in response to the first grayscale signal and a second light-emitting signal in response to the second grayscale signal; and
a switching circuit respectively coupled to the driving circuit and the electroluminescent element, and configured to transmit the first light-emitting signal to the electroluminescent element, drive the electroluminescent element to emit light with a first grayscale of a bit depth, or transmit the second light-emitting signal to the electroluminescent element, drive the electroluminescent element to emit light with a second grayscale, wherein the second grayscale is one of a plurality of sub-grayscales between the first grayscale and a previous or next grayscale of the first grayscale at the bit depth.

24. A display device, comprises:
a display panel; and
a backplane comprising a substrate and the pixel circuit disposed on the substrate, werein the pixel circuit comprises:
a data selecting circuit configured to receive a first data voltage and a second data voltage, and selectively generate a first grayscale signal corresponding to the first data voltage and a second grayscale signal corresponding to the second data voltage according to a time voltage;
a latch circuit coupled to the data selecting circuit and configured to receive and transmit the time voltage;
a driving circuit coupled to the data selecting circuit, and configured to transmit a first light-emitting signal in response to the first grayscale signal and a second light-emitting signal in response to the second grayscale signal; and
a switching circuit respectively coupled to the driving circuit and the electroluminescent element, and configured to transmit the first light-emitting signal to the electroluminescent element, drive the electroluminescent element to emit light with a first grayscale of a bit depth, or transmit the second light-emitting signal to the electroluminescent element, drive the electroluminescent element to emit light with a second grayscale, wherein the second grayscale is one of a plurality of sub-grayscales between the first grayscale and a previous or next grayscale of the first grayscale at the bit depth.
